(19) United States
(12) Patent Application Publication
(10) Pub. No.: US 2016/0154501 A1
(43) Pub. Date: Jun. 2, 2016

(54) DISPLAY DEVICE

(71) Applicant: Japan Display Inc., Tokyo (JP)

(72) Inventors: Koji NOGUCHI, Tokyo (JP); Naosuke FURUTANI, Tokyo (JP); Osamu ISHIGE, Tokyo (JP); Atsushi NAKAMURA, Tokyo (JP)

(21) Appl. No.: 14/946,113

(22) Filed: Nov. 19, 2015

(30) Foreign Application Priority Data
Nov. 27, 2014 (JP) 2014-240376

(51) Int. Cl. G06F 3/044; G02F 1/1333; G02F 1/1335; G06F 3/041

(52) U.S. Cl. CPC G06F 3/044; G06F 3/0412; G06F 3/0416; G02F 1/13338; G02F 1/133528; G06F 2203/04108

(57) ABSTRACT

A display device includes a display panel having a top surface and a bottom surface on the opposite side of the top surface and displays an image on the top surface, and a cover member covers the bottom surface of the display panel. The display panel includes a detecting element for detecting an object approaching the top surface. Also, the cover member is adhered to the bottom surface via the adhesive layer.

### CROSS-REFERENCE TO RELATED APPLICATIONS

The present application claims priority from Japanese Patent Application No. 2014-240376 filed on Nov. 27, 2014, the content of which is hereby incorporated by reference into this application.

### TECHNICAL FIELD OF THE INVENTION

The present invention relates to a display device, and particularly relates to a display device having an electrostatic capacitive type input device.

### BACKGROUND OF THE INVENTION

In recent years, technique of attaching an input device referred to as a touch panel or a touch sensor to a display plane side of a display device and detecting and outputting an input position when input operations are performed by contacting the touch panel with a finger or an input tool such as a stylus pen has been known. Such display devices having a touch panel are widely used in portable information terminals such as mobile phones in addition to computers.

One detecting method for detecting contact positions at which a finger or the like has contacted the touch panel is the electrostatic capacitance method. In an electrostatic capacitive type touch panel, a plurality of capacitive elements each made up of a pair of electrodes disposed to be opposed to each other with a dielectric layer interposed therebetween, that is, a driving electrode and a detecting electrode are provided in a plane of the touch panel. Then, the input positions are detected by utilizing the characteristics that the electrostatic capacitance of capacitive elements changes when performing input operations by contacting the capacitive elements with a finger or an input tool such as a stylus pen.

Also, in the display device to which an input device is not attached, a reinforcing member or a cover member may be provided on the rear side of the display device.

For example, Japanese Patent Application Laid-Open Publication No. 2013-104969 (Patent Document 1) describes a technique in which a reinforcing member is disposed between a polarizing plate of a backlight side and a light modulating panel or a fixed layer in a display device. In addition, Japanese Patent Application Laid-Open Publication No. 6-258637 (Patent Document 2) describes a technique in which a liquid crystal display device includes a transparent cover member mounted on outer surfaces of liquid crystal cells.

### SUMMARY OF THE INVENTION

In the aforementioned display device having an electrostatic-capacitive type touch panel, when the cover member made of, for example, glass is provided on a surface of the display device having a touch panel, for example, for the purpose of reinforcing the strength of the display device, an intensity of the detecting signal for the cover member is reduced.

Therefore, when the cover member is not provided on the surface of the display device having a touch panel, the display device is easily bent in such a way that the display device is pressed from the surface. Also, the display panel is supported in such a way that four side portions of a rear surface of the display panel come into contact with a support member for example, for the purpose not to damage the rear surface of the display panel. Therefore, when the cover member is not provided on the surface of the display device having a touch panel, the display panel is more easily bent. In addition, a spot occurs on an image displayed on the display device due to bending of the display panel.

The present invention has been made in an effort to solve the above-described problems of the prior art, and an object of the present invention is to provide a display device capable of preventing or suppressing bending of a display panel upon touch input, thereby preventing or suppressing occurrence of a spot in a displayed image due to bending of a display panel.

The following is a brief description of an overview of the typical invention disclosed in the present application.

A display device as one aspect of the present invention includes: a display panel including a first surface, and a second surface on the opposite side of the first surface, and displays an image on the first surface; and a first member configured to cover the second surface of the display panel. The display panel includes a detecting element for detecting an object approaching the first surface. Also, the first member is adhered to the second surface via an adhesive layer.

Additional features and advantages are described herein, and will be apparent from the following Detailed Description and the figures.

### BRIEF DESCRIPTION OF THE DRAWINGS

FIG. 1 is a block diagram illustrating one configuration example of a display device according to an embodiment;

FIG. 2 is an explanatory diagram illustrating a state in which a finger contacts or approaches a touch detection device;

FIG. 3 is an explanatory diagram illustrating an example of an equivalent circuit of a touch detection device;

FIG. 4 is a plan view illustrating one example of a module having the display device according to the embodiment;

FIG. 5 is a sectional view illustrating a display device with a touch detection function in the display device according to the embodiment;

FIG. 6 is a circuit diagram illustrating a display device with a touch detection function in the display device according to the embodiment;

FIG. 7 is a perspective view illustrating one configuration example of driving electrodes and detecting electrodes of the display device according to the embodiment;

FIG. 8 is a sectional view illustrating a support structure by a cover member of a display panel in the display device according to the embodiment;

FIG. 9 is a sectional view illustrating a support structure by a backlight unit of a display panel in the display device according to the embodiment;

FIG. 10 is an exploded perspective view illustrating a support structure by a backlight unit of a display panel in the display device according to the embodiment;

FIG. 11 is an exploded perspective view illustrating a structure of a backlight unit in the display device according to the embodiment;

FIG. 12 is a diagram for describing a calculation method for a distortion amount;

FIG. 13 is a diagram for describing a calculation method for a distortion amount;

FIG. 14 is a diagram for describing a calculation method for a distortion amount;

FIG. 15 is a sectional view illustrating a support structure by a cover member of a display panel in a display device according to a first modification example of the embodiment;

FIG. 16 is a sectional view illustrating a support structure by a cover member of a display panel in a display device according to a second modification example of the embodiment;

FIG. 17 is an explanatory diagram illustrating an electrical connection state of electrostatic capacitive type detecting electrodes; and

FIG. 18 is an explanatory diagram illustrating an electrical connection state of electrostatic capacitive type detecting electrodes.

### DESCRIPTIONS OF THE PREFERRED EMBODIMENTS

Hereinafter, embodiments of the present invention will be described with reference to the drawings.

Note that the disclosures are provided by way of example, and any suitable variations easily conceived by a person with ordinary skill in the art while pertaining to the gist of the invention are of course included in the scope of the present invention. Further, in the drawings, widths, thicknesses and shapes of respective components may be schematically illustrated in comparison with the embodiments for the purpose of making the description more clearly understood, but these are merely examples, and do not limit the interpretations of the present invention.

Further, in the specification and drawings, elements which are similar to those already mentioned with respect to previous drawings are denoted by the same reference characters, and detailed descriptions thereof will be suitably omitted.

Also, in the drawings used in the following embodiments, hatching used to discriminate structures from each other is sometimes omitted.

Moreover, in the embodiments described below, when a range is shown as A to B, that range means A or more and B or less unless specifically mentioned.

### EMBODIMENT

First, an example in which a display device provided with a touch panel as an input device is applied to an in-cell type liquid crystal display device with a touch detection function will be described as the embodiment. Also, in this specification, an input device refers to an input device that detects an electrostatic capacitance varying depending on a capacitance of an object approaching or contacting at least an electrode. In this case, a method of detecting an electrostatic capacitance includes not only mutual capacitance method of detecting an electrostatic capacitance between two electrodes but also a self-capacitance method of detecting an electrostatic capacitance of one electrode. Also, a liquid crystal display device with a touch detection function refers to a liquid crystal display device in which a detecting electrode for touch detection is provided in any one of a first substrate and a second substrate which are included in a display panel. In addition, in the embodiment, there will be described an in-cell type liquid crystal device with a touch detection function, which has characteristics in which a driving electrode of a display panel is provided so as to operate as a driving electrode of a touch panel.

<Overall Configuration>

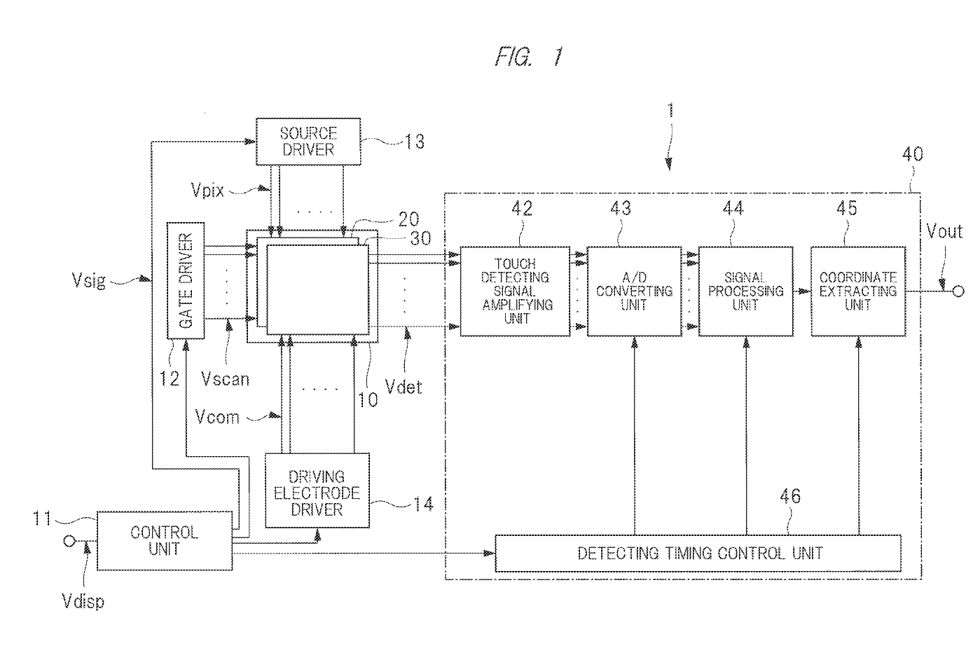

First, the overall configuration of the display device according to the present embodiment will be described with reference to FIG. 1. FIG. 1 is a block diagram illustrating one configuration example of the display device according to the embodiment.

A display device 1 includes a display device 10 with a touch detection function, a control unit 11, a gate driver 12, a source driver 13, a driving electrode driver 14, and a touch detection unit 40.

The display device 10 with a touch detection function includes a display device 20 and a touch detection device 30. In the present embodiment, the display device 20 is a display device using liquid crystal display elements as display elements. The touch detection device 30 is an electrostatic-capacitive type touch detection device, that is, an electrostatic capacitive type touch detection device. Therefore, the display device 1 is a display device including an input device with a touch detection function. Furthermore, the display device 10 with a touch detection function is a display device in which at least a configuration of the liquid crystal display device 20 is at least partly integrated with a configuration of the touch detection device 30 like an electrode of the liquid crystal display device 20 and an electrode of the touch detection device 30 are commonly used or an electrode for the touch detection device is provided on a substrate included in the liquid crystal display device 20, for example. Also, the display device 10 is a display device incorporating a touch detection function, that is, an in-cell type display device with a touch detection function.

Further, the display device 10 with a touch detection function may be a display device in which the touch detection device 30 is attached on the display device 20 without commonly using a configuration of the liquid crystal display device 20 and a configuration of the touch detection device 30. Further, it is also possible to use, for example, an organic EL (Electroluminescence) display device instead of the display device using liquid crystal elements for the display device 20.

The display device 20 performs display by sequentially scanning each horizontal line in the display region in accordance with scanning signals Vscan supplied from the gate driver 12. The touch detection device 30 operates in accordance with a principle of electrostatic capacitive touch detection and outputs detecting signals Vdet as will be described later.

The control unit 11 is a circuit which respectively supplies control signals to the gate driver 12, the source driver 13, the driving electrode driver 14 and the touch detection unit 40 based on video signals Vdisp supplied from outside for controlling them so that they are operated in synchronization with each other.

The gate driver 12 has a function of sequentially selecting one horizontal line, which is an object of display driving of the display device 10 with a touch detection function, based on control signals supplied from the control unit 11.

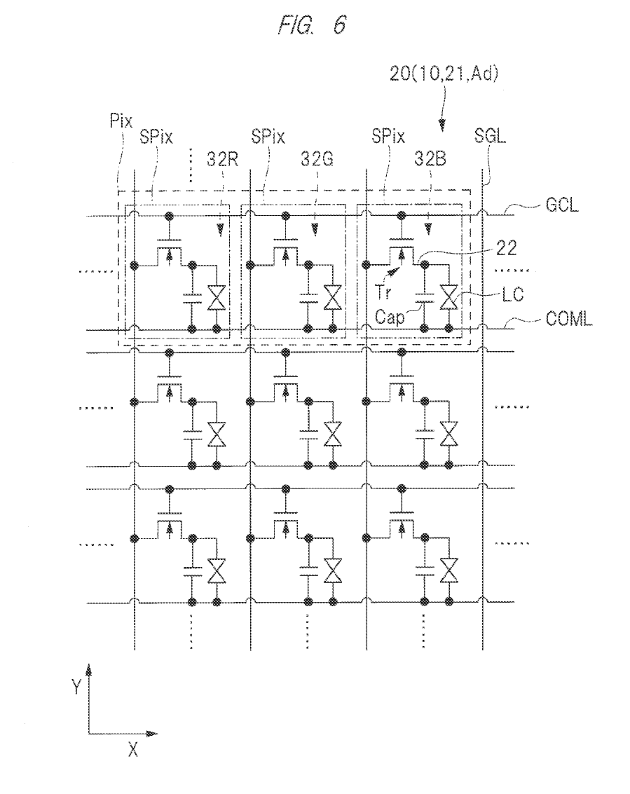

The source driver 13 is a circuit which supplies pixel signals Vpix to sub-pixels SPix included in the display device 10 with a touch detection function (see FIG. 6 to be described later) based on control signals of image signals Vsig supplied from the control unit 11.

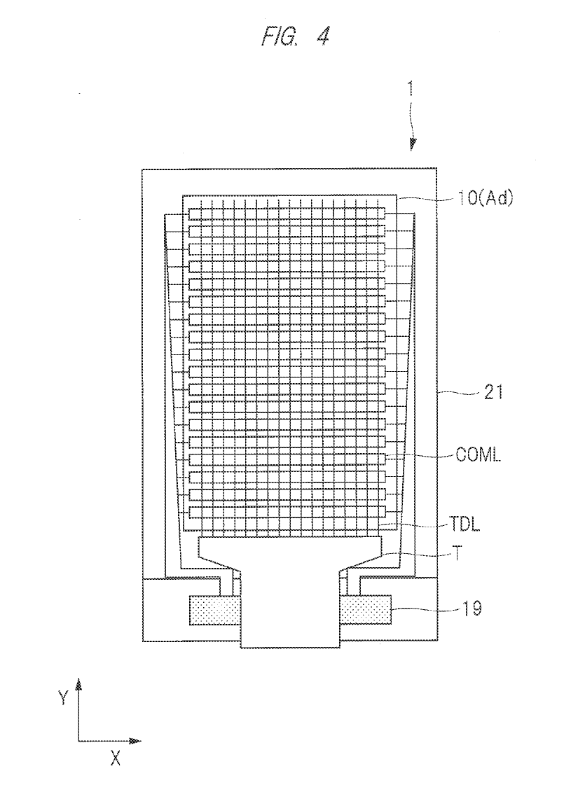

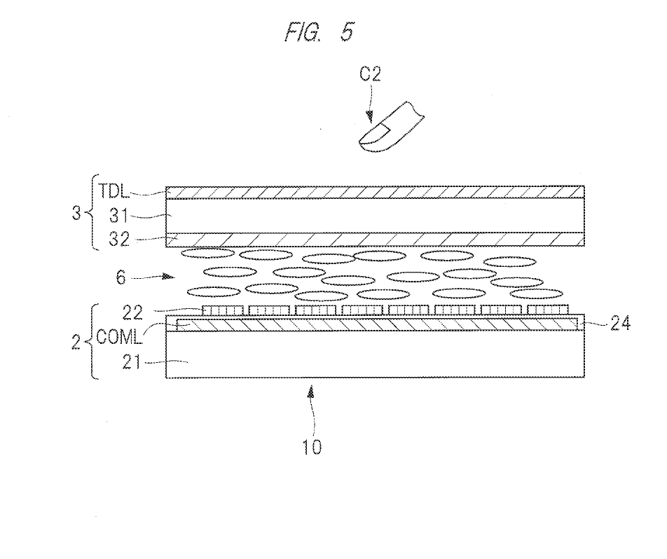

The driving electrode driver 14 is a circuit which supplies driving signals Vcom to driving electrodes COML included in the display device 10 with a touch detection function (see FIG. 4 or FIG. 5 to be described later) based on control signals supplied from the control unit 11.

The touch detection unit 40 is a circuit which detects presence/absence of touches of a finger or an input tool such as a stylus pen to the touch detection device 30, namely, a state of contact or approach to be described later based on control signals supplied from the control unit 11 and detecting signals Vdet supplied from the touch detection device 30 of the display device 10 with a touch detection function. Also, the touch detection unit 40 is a circuit which obtains coordinates of touches, namely input positions in the touch detection region in the case where the touches are present. The touch detection unit 40 includes a touch detecting signal amplifying unit 42, an A/D (Analog/Digital) converting unit 43, a signal processing unit 44, a coordinate extracting unit 45 and a detection timing control unit 46.

The touch detecting signal amplifying unit 42 amplifies detecting signals Vdet supplied from the touch detection device 30. The touch detecting signal amplifying unit 42 may be provided with a low pass analog filter which removes high frequency components, namely, noise components included in the detecting signals Vdet and extracts and respectively outputs touch components.

<Principle of Electrostatic Capacitive Touch Detection>

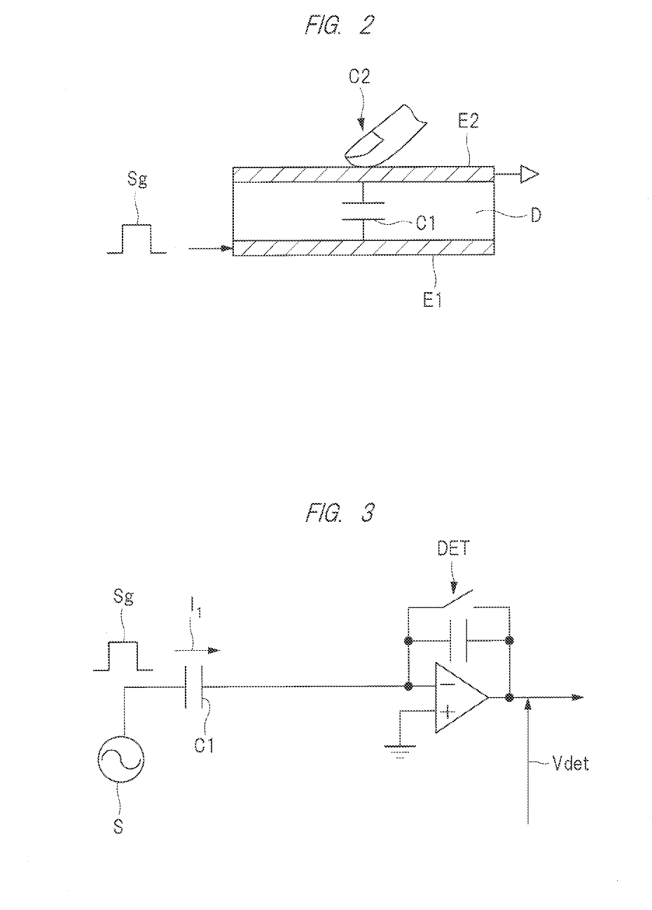

Next, the principle of touch detection in the display device 1 according to the present embodiment will be described with reference to FIG. 1 to FIG. 3. FIG. 2 is an explanatory diagram illustrating a state in which a finger contacts or approaches a touch detection device. FIG. 3 is an explanatory diagram illustrating an example of an equivalent circuit of a touch detection device.

As illustrated in FIG. 2, in the electrostatic capacitive touch detection, an input device referred to as a touch panel or a touch sensor includes a driving electrode E1 and a detecting electrode E2 which are disposed to be opposed to each other with a dielectric body D interposed therebetween. A capacitive element C1 is formed by the driving electrode E1 and the detecting electrode E2. As illustrated in FIG. 3, one end of the capacitive element C1 is coupled with an AC signal source S which is a driving signal source, and the other end of the capacitive elements C1 is coupled with a voltage detector DET which is the touch detection unit. The voltage detector DET is, for example, an integrating circuit included in the touch detecting signal amplifying unit 42 illustrated in FIG. 1.

When an AC rectangular wave Sg having a frequency in the range of, for example, several kHz to several hundreds kHz is applied from the AC signal source S to the one end of the capacitive element C1, namely, the driving electrode E1, a detecting signal Vdet which is an output waveform is generated via the voltage detector DET coupled to the other end of the capacitive element C1, namely, the detecting electrodes E2 side.

In the state in which no finger contacts or approaches, namely, in the non-contact state, as illustrated in FIG. 3, current I₁ corresponding to the capacitance value of the capacitive element C1 flows in accordance with charge and discharge of the capacitive element C1. The voltage detector DET converts the fluctuation in the current I₁ in accordance with the AC rectangular wave Sg into the fluctuation in voltage.

On the other hand, in a state in which a finger contacts or approaches, namely, in the contact state, the capacitive element C1 formed of the driving electrode E1 and the detecting electrode E2 is affected by the electrostatic capacitance C2 formed by the finger and the capacitance value of the capacitive element C1 formed of the driving electrode E1 and the detecting electrode E2 is reduced. Therefore, the current I₁ flowing through the capacitive element C1 illustrated in FIG. 3 fluctuates. The voltage detector DET converts the fluctuation in the current I₁ in accordance with the AC rectangular wave Sg into the fluctuation in voltage.

In the example shown in FIG. 1, the touch detection device 30 performs touch detection for each driving range including one or a plurality of driving electrodes COML (see FIG. 5 or FIG. 6 to be described later) in accordance with the driving signal Vcom supplied from the driving electrode driver 14. More specifically, the touch detection device 30 outputs the detecting signal Vdet via the voltage detector DET illustrated in FIG. 3 for each driving range including the one or plurality of driving electrodes COML, and supplies the output detecting signal Vdet to the touch detecting signal amplifying unit 42 of the touch detection unit 40.

The A/D converting unit 43 is a circuit which samples each analog signal output from the touch detecting signal amplifying unit 42 at a timing in synchronization with the driving signal Vcom, thereby converting it into a digital signal.

The signal processing unit 44 is provided with a digital filter which reduces frequency components other than the frequency at which the driving signal Vcom is sampled, namely, noise components included in the output signal of the A/D converting unit 43. The signal processing unit 44 is a logic circuit which detects presence/absence of touches to the touch detection device 30 based on the output signal of the A/D converting unit 43. The signal processing unit 44 performs the process of extracting only differential voltage caused by the finger. The signal processing unit 44 compares the detected differential voltage caused by the finger with a predetermined threshold voltage, and when the voltage is equal to or higher than the threshold voltage, it is determined to be the contact state of an externally approaching object which approaches from outside, and when the voltage is lower than the threshold voltage, it is determined to be the non-contact state of an externally approaching object. In this manner, touch detection is performed by the touch detection unit 40.

The coordinate extracting unit 45 is a logic circuit which obtains the coordinates of the position at which the touch has been detected by the signal processing unit 44, namely, the input position on the touch panel. The detection timing control unit 46 controls the A/D converting unit 43, the signal processing unit 44 and the coordinate extracting unit 45 so that they are operated in synchronization with each other. The coordinate extracting unit 45 outputs the touch panel coordinates as a signal output Vout.

<Module>

FIG. 4 is a plan view illustrating one example of a module having the display device according to the embodiment.

As shown in FIG. 4, the display device 1 includes the display device 10 with a touch detection function and a COG (chip on glass) 19.

The display device 10 with a touch detection function includes a plurality of driving electrodes COML and a plurality of detecting electrodes TDL. Here, two directions which mutually intersect, preferably orthogonally, with each other within a top surface serving as a main surface of a substrate 21 are defined to be an X axis direction and a Y axis direction. At this time, the plurality of driving electrodes COML respectively extend in the X axis direction, and are arranged in the Y axis direction. Further, the plurality of detecting electrodes TDL respectively extend in the Y axis direction, and are arranged in the X axis direction when seen in a plan view. More specifically, each of the plurality of detecting electrodes TDL intersects the plurality of driving electrodes COML when seen in a plan view. Note that the region in which the display device 10 with a touch detection function is formed is the same region as the display region Ad in which images are displayed.

Note that the expression “when seen in a plan view” in the present specification indicates the case in which components are seen from a direction perpendicular to the top surface serving as the main surface of the substrate 21.

As will be described later with reference to FIG. 6, each of the plurality of driving electrodes COML is provided so as to overlap the plurality of sub-pixels SPix arrayed in the X axis direction when seen in a plan view. More specifically, one driving electrode COML is provided as a common electrode for the plurality of sub-pixels SPix.

In the example illustrated in FIG. 4, the display device 10 with a touch sensing function has a rectangular shape with two sides respectively extending in the X axis direction and two sides respectively extending in the Y axis direction when seen in a plan view. A terminal unit T formed of a flexible substrate or the like is provided on one side of the display device 10 with a touch sensing function in the Y axis direction. The detecting electrode TDL is coupled to the touch detection unit 40 (see FIG. 1) mounted to the outside of the module via the terminal unit T. The COG 19 is a chip mounted on the substrate 21, and incorporates respective circuits necessary for display operations such as the control unit 11, the gate driver 12, the source driver 13 or the like, illustrated in FIG. 1. Note that the driving electrode driver 14 illustrated in FIG. 1 may be incorporated in the COG 19. Alternatively, a part of the circuits like the gate driver 12, the source driver 13, etc. may be formed in a peripheral circuit outside the display region.

<Display Device with Touch Detection Function>

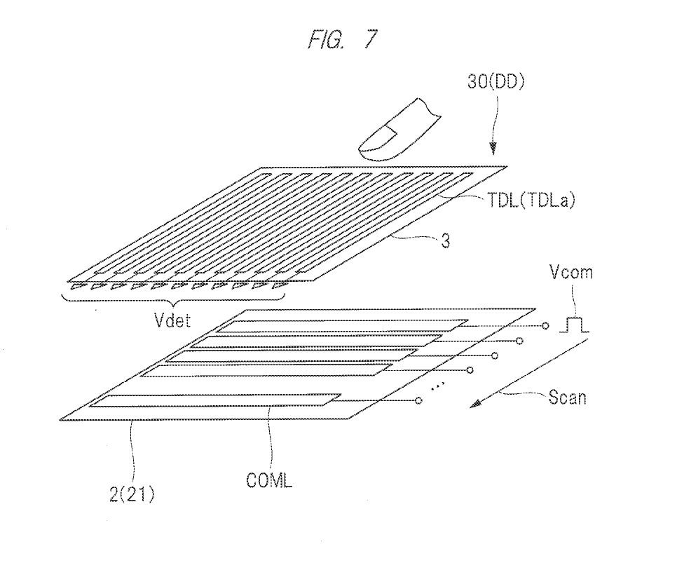

Next, a configuration example of the display device 10 with a touch detection function will be described in details with reference to FIGS. 4 to 7. FIG. 5 is a sectional view illustrating a display device with a touch detection function in the display device according to the embodiment. FIG. 6 is a circuit diagram illustrating the display device with a touch detection function in the display device according to the embodiment. FIG. 7 is a perspective view illustrating one configuration example of driving electrodes and detecting electrodes of the display device according to the embodiment.

The display device 10 with a touch detection function includes an array substrate 2, an opposing substrate 3, and a liquid crystal layer 6. The opposing substrate 3 is disposed to face the array substrate 2 so that an top surface serving as a main surface of the array substrate 2 and a bottom surface serving as a main surface of the opposing substrate 3 face each other. The liquid crystal layer 6 is provided between the array substrate 2 and the opposing substrate 3.

The array substrate 2 includes the substrate 21. Also, the opposing substrate 3 includes the substrate 31. The substrate 31 has a top surface serving as one main surface and a bottom surface serving as another main surface on the opposite side of the top surface, and is disposed to face the substrate 21 such that a top surface serving as a main surface of the substrate 21 and the bottom surface serving as the main surface of the substrate 31 face each other. Also, the liquid crystal layer 6 is disposed between a top surface of the substrate 21 and a bottom surface of the substrate 31.

As illustrated in FIG. 6, in the display region Ad, a plurality of scanning lines GCL, a plurality of signal lines SGL, and a plurality of TFT elements Tr that are thin film transistors (TFT) are formed in the substrate 21. Note that, in FIG. 5, the illustration of the scanning lines GCL, the signal lines SGL, and the TFT elements Tr is omitted. Also, the scanning line represents a gate wiring, and the signal line represents a source wiring.

As illustrated in FIG. 6, the plurality of scanning lines GCL respectively extend in the X axis direction and are arranged in the Y axis direction in the display region Ad. The plurality of signal lines SGL respectively extend in the Y axis direction and are arranged in the X axis direction in the display region Ad. Accordingly, each of the plurality of signal lines SGL intersects the plurality of scanning lines GCL when seen in a plan view. In this manner, when seen in a plan view, sub-pixels SPix are arranged at the intersections of the plurality of scanning lines GCL and the plurality of signal lines SGL which intersect each other, and a single pixel Pix is formed by a plurality of sub-pixels SPix having different colors. More specifically, the plurality of sub-pixels SPix are provided on the top surface of the substrate 21, and when seen in a plan view, are arranged in a matrix form in the X axis direction and the Y axis direction in the display region Ad.

The TFT element Tr is formed at an intersecting portion at which each of the plurality of scanning lines GCL and each of the plurality of signal lines SGL intersect each other when seen in a plan view. Accordingly, in the display region Ad, the plurality of TFT elements Tr are formed on the substrate 21, and the plurality of TFT elements Tr are arranged in a matrix form in the X axis direction and the Y axis direction. More specifically, each of the plurality of sub-pixels SPix is provided with the TFT element Tr. Also, each of the plurality of sub-pixels SPix is provided with a liquid crystal element LC in addition to the TFT element Tr.

The TFT element Tr is made up of, for example, a thin film transistor such as an n-channel MOS (metal oxide semiconductor). A gate electrode of the TFT element Tr is coupled to the scanning line GCL. One of a source electrode and a drain electrode of the TFT element Tr is coupled to the signal line SGL. The other one of the source electrode and the drain electrode of the TFT element Tr is coupled to one end of the liquid crystal element LC. For example, one end of the liquid crystal element LC is coupled to the source electrode or the drain electrode of the TFT element Tr, and the other end thereof is coupled to the driving electrode COML.

As illustrated in FIG. 5, the array substrate 2 includes the substrate 21, the plurality of driving electrodes COML, an insulating film 24, and a plurality of pixel electrodes 22. The plurality of driving electrodes COML are provided on the top surface serving as one main surface side of the substrate 21 in the display region Ad when seen in a plan view. The insulating film 24 is formed on the top surface of the substrate 21 with the inclusion of front surfaces of the plurality of driving electrodes COML. In the display region Ad, the plurality of pixel electrodes 22 are formed on the insulating film 24. Accordingly, the insulating film 24 electrically insulates the driving electrodes COML and the pixel electrodes 22.

Although the driving electrodes COML, the insulating film 24, and the pixel electrodes 22 are arranged in the order thereof to the substrate 21 in the present embodiment, the present invention is not limited thereto, and the pixel electrodes 22, the insulating film 24, and the driving electrodes COML may be arranged in the order thereof.

As illustrated in FIG. 6, when seen in a plan view, the plurality of pixel electrodes 22 are formed respectively within the plurality of sub-pixels SPix, which are arranged in a matrix form in the X axis direction and the Y axis direction, in the display region Ad. Accordingly, the plurality of pixel electrodes 22 are arranged in a matrix form in the X axis direction and the Y axis direction.

In the example illustrated in FIG. 5, each of the plurality of driving electrodes COML is formed between the substrate 21 and the pixel electrode 22. Also, as schematically illustrated in FIG. 6, each of the plurality of driving electrodes COML is provided so as to overlap the plurality of pixel electrodes 22 when seen in a plan view. Then, by applying voltage between each of the plurality of pixel electrodes 22 and each of the plurality of driving electrodes COML so that electric field is formed between each of the plurality of pixel electrodes 22 and each of the plurality of driving electrodes COML, that is, in the liquid crystal element LC provided in each of the plurality of sub-pixels SPix, an image is displayed in the display region Ad. In this case, a capacitance Cap is formed between the driving electrode COML and the pixel electrode 22, and the capacitance Cap functions as a holding capacitance.

The liquid crystal display device 20 is formed by the liquid crystal elements LC, the plurality of pixel electrodes 22, the driving electrodes COML, the plurality of scanning lines GCL, and the plurality of signal lines SGL. Display of an image in the display region Ad of the liquid crystal display device 20 is controlled by controlling voltage applied between each of the plurality of pixel electrodes 22 and each of the plurality of driving electrodes COML by a display control unit including the source driver 13, the gate driver 12, and the control unit 11. The display control unit including the source driver 13, the gate driver 12, and the control unit 11 is provided between the substrate 21 and the substrate 31.

Note that each of the plurality of driving electrodes COML may be formed on the opposite side of the substrate 21 with the pixel electrodes 22 being interposed therebetween. Also, in the example illustrated in FIG. 5, the driving electrodes COML and the pixel electrodes 22 are disposed to overlap each other when seen in a plan view as an arrangement in a transverse electric field mode. However, the arrangement of the driving electrodes COML and the pixel electrodes 22 may be an arrangement in which the driving electrodes COML and the pixel electrodes 22 do not overlap each other when seen in a plan view. Alternatively, the arrangement of the driving electrodes COML and the pixel electrodes 22 may be a twisted nematic (TN) mode or a vertical alignment (VA) mode as a longitudinal electric field mode of arranging one of the electrodes on an opposing substrate side.

The liquid crystal layer 6 modulates light passing therethrough according to a state of an electric field, and a liquid crystal layer corresponding to, for example, the aforementioned transverse electric field mode, such as IPS mode is used. That is, as the liquid crystal display device 20, a liquid crystal display device according to the transverse electric field mode, such as IPS mode is used. Alternatively, as described above, a liquid crystal display device according to the longitudinal electric field mode, such as TN mode or VA mode may be used. Also, an alignment layer may be provided between the liquid crystal layer 6 and the array substrate 2 illustrated in FIG. 5, and between the liquid crystal layer 6 and the opposing substrate 3.

As shown in FIG. 6, the plurality of sub-pixels SPix arranged in the X axis direction, that is, the plurality of sub-pixels SPix which belong to the same row of the liquid crystal display device 20 are coupled to each other by the scanning lines GCL. The scanning lines GCL are coupled to the gate driver 12 (see FIG. 1) and scanning signals Vscan (see FIG. 1) are supplied thereto by the gate driver 12. Also, the plurality of sub-pixels SPix arranged in the Y axis direction, that is, the plurality of sub-pixels SPix which belong to the same column of the liquid crystal display device 20 are coupled to each other by the signal lines SGL. The signal lines SGL are coupled to the source driver 13 (see FIG. 1) and pixel signals Vpix (see FIG. 1) are supplied thereto by the source driver 13. Further, the plurality of sub-pixels SPix arranged in the X axis direction, that is, the plurality of sub-pixels SPix which belong to the same row of the liquid crystal display device 20 are coupled to each other by the driving electrodes COML.

The driving electrodes COML are coupled to the driving electrode driver 14 (see FIG. 1) and driving signals Vcom (see FIG. 1) are supplied thereto by the driving electrode driver 14. In the example illustrated in FIG. 6, the plurality of sub-pixels SPix which belong to the same row share one driving electrode COML. The plurality of driving electrodes COML respectively extend in the X axis direction and are arranged in the Y axis direction in the display region Ad. As described above, since the plurality of scanning lines GCL respectively extend in the X axis direction and are arranged in the Y axis direction in the display region Ad, the direction in which each of the plurality of driving electrodes COML extends is parallel to the direction in which each of the plurality of scanning lines GCL extends. However, the direction in which each of the plurality of driving electrodes COML extends is not limited, and for example, the direction in which each of the plurality of driving electrodes COML extends may be a direction which is parallel to the direction in which each of the plurality of signal lines SGL extends.

The gate driver 12 illustrated in FIG. 1 sequentially selects one row, namely, one horizontal line from among the sub-pixels SPix which are arranged in a matrix form in the liquid crystal display device 20 as an object of display driving by applying the scanning signal Vscan to the gate electrode of the TFT element Tr of each of the sub-pixels SPix via the scanning lines GCL illustrated in FIG. 6. The source driver 13 shown in FIG. 1 supplies the pixel signals Vpix respectively to the plurality of sub-pixels SPix which constitute one horizontal line sequentially selected by the gate driver 12 via the signal lines SGL illustrated in FIG. 6. Then, display in accordance with the supplied pixel signals Vpix are made at the plurality of sub-pixels SPix constituting one horizontal line.

The driving electrode driver 14 illustrated in FIG. 1 applies driving signals Vcom to drive the driving electrodes COML for each driving range including one or a plurality of driving electrodes COML.

In the liquid crystal display device 20, the gate driver 12 is driven so as to sequentially scan the scanning lines GCL on time division basis, thereby sequentially selecting the sub-pixels SPix for each horizontal line. Also, in the liquid crystal display device 20, the source driver 13 supplies pixel signals Vpix to the sub-pixels SPix which belong to one horizontal line, so that display are made for each horizontal line. In performing the display operation, the driving electrode driver 14 supplies driving signals Vcom to driving electrodes COML included in a driving range corresponding to the one horizontal line.

The driving electrodes COML of the display device 1 according to the present embodiment operate as driving electrodes of the liquid crystal display device 20 and also operate as driving electrodes of the touch detection device 30. FIG. 7 is a perspective view illustrating one configuration example of driving electrodes and detecting electrodes of the display device according to the embodiment.

The touch detection device 30 includes a plurality of driving electrodes COML provided on the array substrate 2 and a plurality of detecting electrodes TDL provided on the opposing substrate 3. The plurality of detecting electrodes TDL respectively extend in the direction which intersects the direction in which each of the plurality of driving electrodes COML extends when seen in a plan view. In other words, the plurality of detecting electrodes TDL are arranged at intervals from one another so as to respectively intersect the plurality of driving electrodes COML when seen in a plan view. Also, the plurality of detecting electrodes TDL respectively face the plurality of driving electrodes COML in a direction perpendicular to the top surface of the substrate 21 included in the array substrate 2.

The plurality of detecting electrodes TDL is respectively coupled to the touch detecting signal amplifying unit 42 (see FIG. 1) of the touch detection unit 40. An electrostatic capacitance is generated at intersecting portions between each of the plurality of driving electrodes COML and each of the plurality of detecting electrodes TDL seen in a plan view. Input positions are detected based on the electrostatic capacitance between each of the plurality of driving electrodes COML and each of the plurality of detecting electrodes TDL. That is, the touch detection unit 40 detects the input positions based on the electrostatic capacitance between the plurality of driving electrodes COML and the plurality of detecting electrodes TDL.

With the configuration described above, when the touch detection device 30 performs the touch detection operation, for example, one or a plurality of driving electrodes COML is sequentially selected by the driving electrode driver 14 (see FIG. 1). Then, driving signals Vcom are input and supplied to the selected one or plurality of driving electrodes COML, and detecting signals Vdet for detecting input positions are generated and output from the detecting electrodes TDL. In this manner, the touch detection device 30 is configured so as to perform the touch detection for each driving range in which the selected one or plurality of driving electrodes COML is included. The one or plurality of driving electrodes COML included in one driving range corresponds to the driving electrode E1 and the detecting electrode TDL corresponds to the detecting electrode E2, in the above-described principle of touch detection.

As illustrated in FIG. 7, when seen in a plan view, the plurality of driving electrodes COML and the plurality of detecting electrodes TDL, which intersect each other, form electrostatic capacitive type touch sensors arranged in a matrix form. Accordingly, by scanning the entire touch detection surface of the touch detection device 30, positions which have been contacted or approached by a finger or the like can be detected.

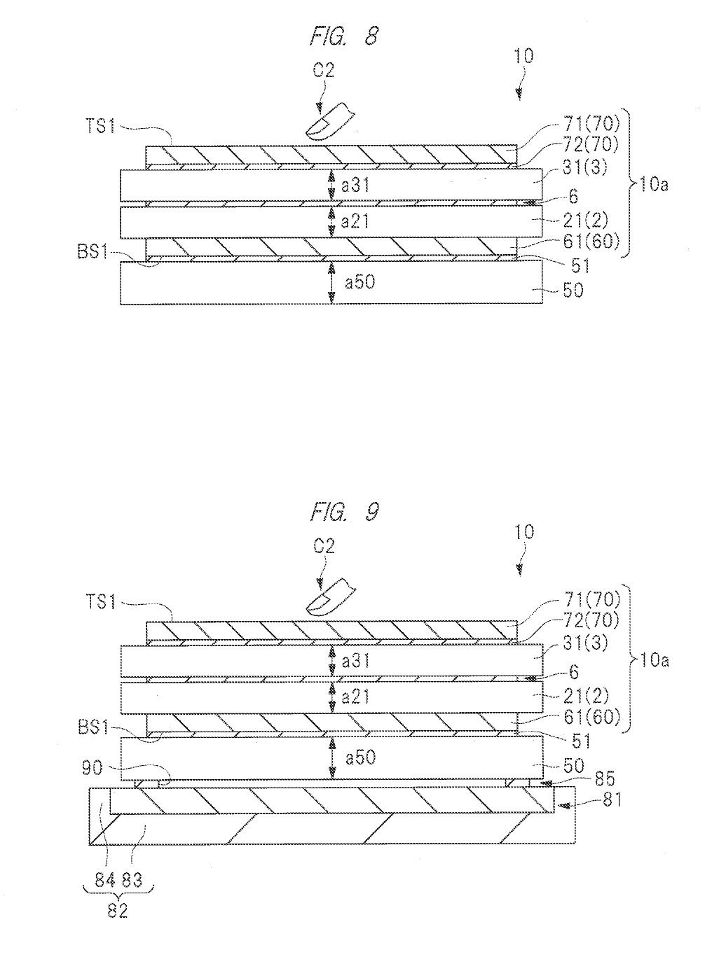

Also, the electrostatic capacitive type touch sensors arranged in a matrix form are also detection elements DD included in the display panel 10a to be described with reference to FIG. 8 later to detect an object approaching a top surface of the display panel 10a.

As illustrated in FIG. 5, the opposing substrate 3 includes a substrate 31, a color filter 32, and the detecting electrodes TDL. The color filter 32 is formed on a bottom surface of the substrate 31. The detecting electrodes TDL are the detecting electrodes of the touch detection device 30, and are formed on a top surface serving as the other main surface of the substrate 31.

For example, color filters colored in three colors of red (R), green (G) and blue (B) are arranged in the X axis direction as the color filter 32. In this manner, as illustrated in FIG. 6, a plurality of sub-pixels SPix corresponding to each of color regions 32R, 32G, and 32B of three colors of R, G, and B are formed, and one pixel Pix is formed by the plurality of sub-pixels SPix each corresponding to one set of the color regions 32R, 32G, and 32B. The pixels Pix are arranged in a matrix form in the direction in which the scanning lines GCL extend (X axis direction) and the direction in which the signal lines SGL extend (Y axis direction). Further, the region in which the pixels Pix are arranged in a matrix form is, for example, the above-described display region Ad.

As a combination of colors of the color filter 32, there may be a combination of a plurality of colors including other colors than R, G and B. Also, it is also possible to provide no color filter 32. Alternatively, one pixel Pix may include a sub-pixel SPix which is not provided with the color filter 32, that is, a white-colored sub-pixel SPix. Also, by a color filter on array (COA) technology, the color filter may be provided in the array substrate 2.

Also, as described with reference to FIG. 8 to be described later, a polarizing plate 60 may be provided on the opposite side of the opposing substrate 3 with the array substrate 2 being interposed therebetween. Also, a polarizing plate 70 may be provided on the opposite side of the array substrate 2 with the opposing substrate 3 being interposed therebetween.

<Support Structure by Cover Member>

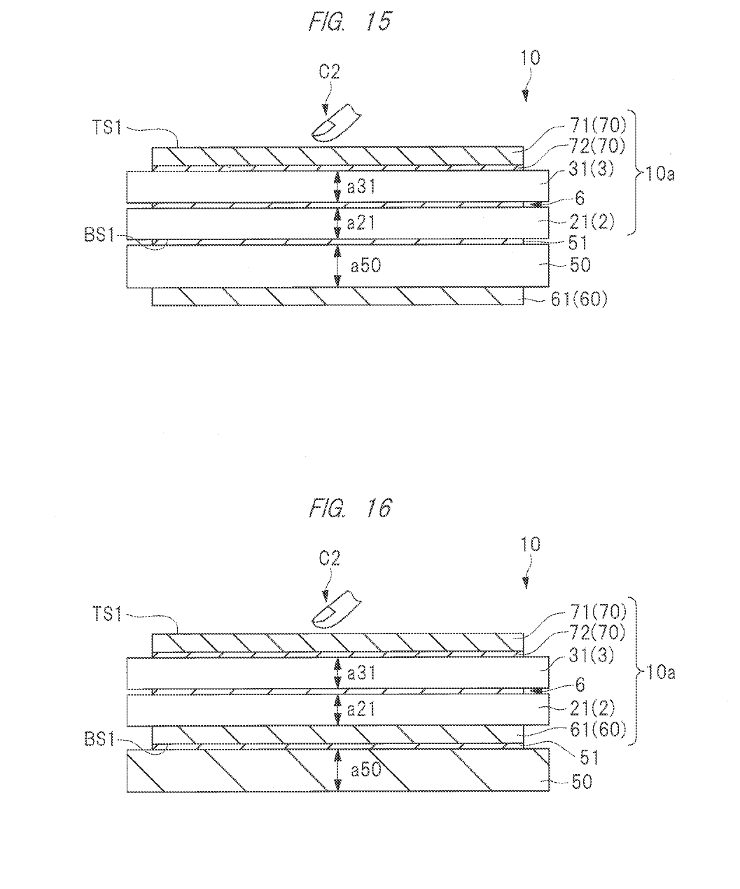

Next, a support structure by a cover member will be described with reference to FIG. 8. FIG. 8 is a sectional view illustrating a support structure by a cover member of a display panel in the display device according to the embodiment. Also, in FIG. 8, for ease of understanding, the illustration of the driving electrodes COML, the insulating film 24, the pixel electrodes 22, the color filter 32, and the detecting electrodes TDL is omitted. That is, in FIG. 8, the substrate 21 is only illustrated as the array substrate 2 and the substrate 31 is only illustrated as the opposing substrate 3 for ease of understanding (also as in FIG. 9, FIG. 15, and FIG. 16).

In the example illustrated in FIG. 8, the display device 10 with a touch detection function in the display device includes a display panel 10a and a cover member 50 serving as a first member. That is, the cover member 50 is an example of the first member.

The display panel 10a has a top surface TS1 and a bottom surface BS1 on the opposite side of the top surface TS1, and displays an image on the top surface TS1. Also, in the present embodiment, there is described an example, in which the display panel 10a is a liquid crystal display panel including the array substrate 2, the opposing substrate 3, and the liquid crystal layer 6.

Also, a position of a layer in which the driving electrodes COML and the detecting electrodes TDL are arranged in a direction perpendicular to the top surface that is a main surface of the substrate 21 is not limited to the example described using FIG. 5. That is, the driving electrodes COML may be formed on any one of the bottom surface of the substrate 21, the top surface of the substrate 21, the bottom surface of the substrate 31, and the top surface of the substrate 31. Alternatively, the detecting electrodes TDL may be formed on any one of the bottom surface of the substrate 21, the top surface of the substrate 21, the bottom surface of the substrate 31, and the top surface of the substrate 31.

The display panel 10a includes a polarizing plate 60 as a second polarizing plate. That is, the polarizing plate 60 is an example of the second polarizing plate. The polarizing plate 60 is provided on the opposite side of the opposing substrate 3 with the array substrate 2 being interposed therebetween. That is, the polarizing plate 60 is provided on a bottom surface BS1 side of the display panel 10a.

The polarizing plate 60 includes, for example, a polarizing layer 61 that is a layer having, for example, a polarization function. The polarizing layer 61 is formed of an insulating film containing, for example, polyvinyl alcohol (PVA) as main ingredients.

Also, although not illustrated, an adhesive layer (not illustrated) may be formed on a surface of the polarizing layer 61 on the array substrate 2 side, and the polarizing plate 60 may be adhered to the array substrate 2 via the adhesive layer. Also, a cover layer containing, for example, triacetylcellulose (TAC) as main ingredients may be formed on a surface of the polarizing layer 61 on the opposite side of the array substrate 2, and a hard coat layer may be further formed on the opposite side of the array substrate 2. Also, a cover layer containing, for example, TAC as main ingredients may be formed on a surface of the polarizing layer 61 on the array substrate 2 side.

The display panel 10a includes a polarizing plate 70 as a first polarizing plate. That is, the polarizing plate 70 is an example of the first polarizing plate. The polarizing plate 70 is provided on the opposite side of the array substrate 2 with the opposing substrate 3 being interposed therebetween. That is, the polarizing plate 70 is provided on a top surface TS1 side of the display panel 10a.

The polarizing plate 70 includes, for example, a polarizing layer 71 that is a layer having a polarization function. Similarly to the polarizing layer 61, the polarizing layer 71 is formed of an insulating film containing, for example, PVA as main ingredients. An adhesive layer 72 is formed on a surface of the polarizing layer 61 on the opposing substrate 3 side. The polarizing plate 70 is adhered to the opposing substrate 3 via the adhesive layer 72.

Preferably, the polarizing plate 70 is not covered by the cover member and is exposed. That is, the cover member is not provided on the opposite side of the cover member 50 with the display panel 10a is interposed therebetween, so that the polarizing plate 70 is exposed. Here, the cover member is made of an insulating material and the cover member may be, for example, a substrate formed of glass or plastic etc. Thereby, it is possible to prevent or suppress a reduction in intensity of a detecting signal in the case of touch input, improving touch detection sensitivity.

Also, in a case where the polarizing plate 70 is not covered by a cover member, it is possible to increase a signal-noise ratio (SNR) of the detecting signal, compared to a case where the polarizing plate 70 is covered by the cover member. For example, when the polarizing plate 70 is covered by a cover member made of glass and is not exposed, an SNR of the detecting signal was 100 in a case where a cylinder made of a conductive material having a diameter of 9 mm as an input tool comes into contact with the central portion of the touch panel. On the other hand, when the polarizing plate 70 is not covered by a cover member and is exposed, an SNR of the detecting signal was 400 in a case where a cylinder made of a conductive material having a diameter of 9 mm as an input tool comes into contact with the central portion of the touch panel.

Also, although not illustrated, a cover layer containing, for example, TAC as main ingredients may be formed on a surface of the polarizing layer 71 on the opposite side of the opposing substrate 3 and a hard coat layer may be further formed on the opposite side of the opposing substrate 3. Also, a cover layer containing, for example, TAC as main ingredients may be formed on a surface of the polarizing layer 71 on the opposing substrate 3 side.

The cover member 50 covers the bottom surface BS1 of the display panel 10a. In the example illustrated in FIG. 8, the cover member 50 covers the bottom surface BS1 that is a surface of the polarizing plate 60 on the opposite side of the array substrate 2. Also, the cover member 50 is adhered to the bottom surface of the polarizing plate 60 via the adhesive layer 51. That is, the cover member 50 is adhered to the bottom surface BS1 of the display panel 10a via the adhesive layer 51. The adhesive layer 51 is formed of a resin film, such as a sponge-like double-sided tape.

In the present embodiment, the cover member 50 which covers the bottom surface BS1 of the display panel 10a is provided. Thereby, when the display panel 10a is pressed from the top surface TS1 upon touch input, it is possible to reduce the distortion amount by which the display panel 10a is distorted in the bottom surface BS1, and prevent and suppress occurrence of a spot on an image displayed on the display panel 10a.

Preferably, a portion of a surface of the cover member 50 on the polarizing plate 60 side, which overlaps the polarizing plate 60 when seen in a plan view, is adhered to the polarizing plate 60 by an entire surface thereof. In other words, a portion of the cover member 50, which overlaps the polarizing plate 60 in a plan view, is adhered to the polarizing plate 60 by an entire surface thereof. Thereby, when the display panel 10a is pressed from the top surface TS1 upon touch input, it is possible to more reduce the distortion amount by which the display panel 10a is distorted in the bottom surface BS1, and more reliably prevent and suppress occurrence of a spot on an image displayed on the display panel 10a.

However, it is not necessary that a portion of a surface of the cover member 50 on the polarizing plate 60 side, which overlaps the polarizing plate 60 when seen in a plan view, is adhered to the polarizing plate 60 by an entire surface thereof. Therefore, a part of a portion of a surface of the cover member 50 on the polarizing plate 60 side, which overlaps the polarizing plate 60 when seen in a plan view, may not adhere to the polarizing plate 60.

Preferably, the cover member 50 can be made of a material, for example, glass; a material having a Young's modulus equal to or greater than a Young's modulus of glass that is a material of the substrate 21 included in the array substrate 2, or a Young's modulus equal to or greater than a Young's modulus of glass that is a material of the substrate 31 included in the opposing substrate 3. Thereby, when the display panel 10a is pressed from the top surface TS1 upon touch input, it is possible to more reduce the distortion amount by which the bottom surface BS1 is distorted, and more reliably prevent and suppress occurrence of a spot on an image displayed on the display panel 10a.

Alternatively, as described in a second modification example of the cover member 50 to be described, the cover member 50 may be made of a material, for example, plastic, such as acrylic, which has a lower Young's modulus than a Young's modulus of the glass that is the material of the substrate 21 or the substrate 31 and also is less likely to break due to a lower mass thereof, compared to the glass. Since Young's modulus of acrylic is lower than the Young's modulus of glass, in a case where the cover member 50 is made of acrylic, a distortion amount of the display panel 10a distorted toward the bottom surface BS1 side is increased when the display panel 10a is pressed from the top surface TS1, compared to a case where the cover member 50 is made of glass. However, the acrylic has a lower mass and is unlikely to be broken, compared to the glass. Therefore, in applications where the display device is lightened even slightly or impact is applied to the display device, the case where the cover member 50 is made of acrylic is benefit, compared to the case where the cover member 50 is made of glass.

Also, in the case of providing the cover member 50 in the bottom surface BS1 of the display panel 10a, it is easy to adjust optical characteristics of the display panel 10a by providing the cover member 50 without changing the optical characteristics of a portion from the polarizing plate 60 to the polarizing plate 70. Therefore, in the terms of easy adjustment of the optical characteristics of the display panel 10a, the display device of the present embodiment is excellent compared to a display device of a first modification example of the embodiment to be described with reference to FIG. 15, that is, a display device in which the polarizing plate 60 is provided on the opposite side of the display panel 10a with the cover member 50 being interposed therebetween.

<Support Structure by Backlight Unit>

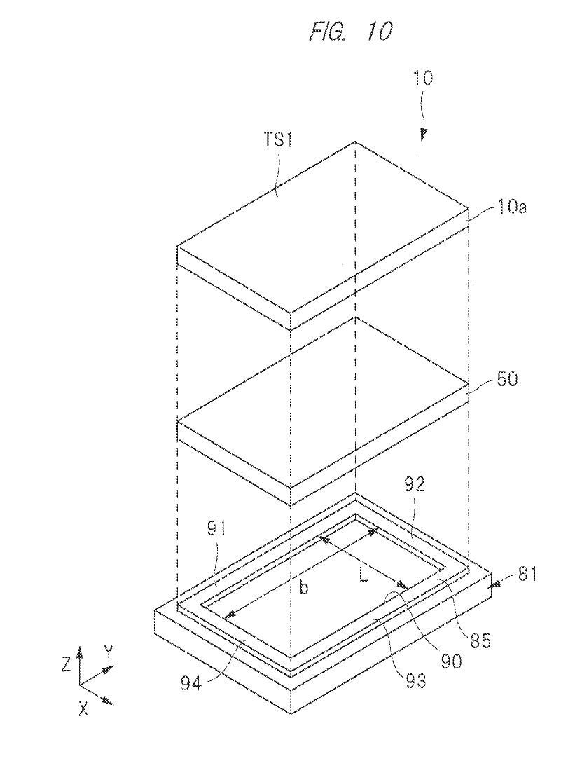

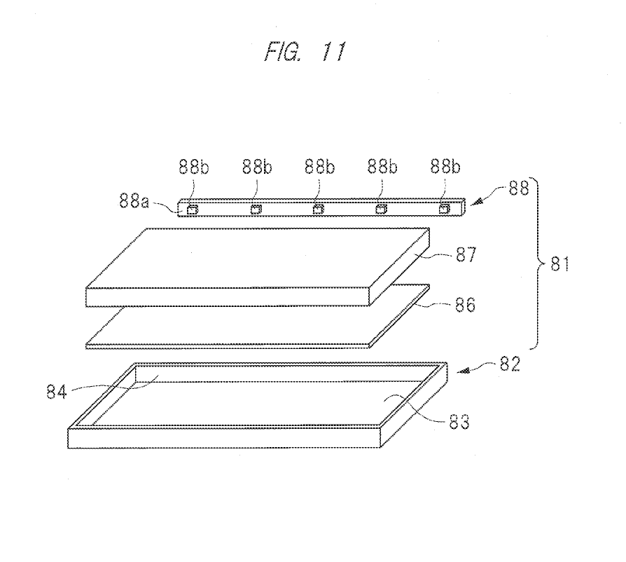

Next, a support structure by a backlight unit will be described with reference to FIGS. 9 to 11. FIG. 9 is a sectional view illustrating a support structure by a backlight unit of a display panel in the display device according to the embodiment. FIG. 10 is a sectional view illustrating a support structure by a backlight unit of a display panel in the display device according to the embodiment. FIG. 11 is an exploded perspective view illustrating a structure of a backlight unit in the display device according to the embodiment.

In the example illustrated in FIGS. 9 to 11, the display device 10 with a touch detection function in the display device includes a display panel 10a, a backlight unit 81 serving as a backlight, and a backlight frame 82. The backlight frame 82, that is, a backlight bezel includes a bottom portion 83 and a frame portion 84 provided in the outer periphery of the bottom portion 83. The backlight unit 81 is provided on the bottom portion 83 in a region surrounded by the frame portion 84. Also, the display panel 10a is disposed on the backlight unit 81 via a support member 85 and the cover member 50 in the region surrounded by the frame portion 84. Specifically, the polarizing plate 60 is disposed above the backlight unit 81 via the support member 85 and the cover member 50.

In other words, the support member 85 is disposed on the opposite side of the display panel 10a with the cover member 50 being interposed therebetween. Also, the backlight unit 81 is disposed on the opposite side of the cover member 50 with the support member 85 being interposed. The backlight unit 81 supports the support member 85. Note that the support member 85 is an example of a second member. In still other words, the support member 85 is disposed opposite to the display panel 10a, and the cover member 50 is interposed between the support member 85 and the display panel 10a. In addition, the backlight unit 81 is disposed opposite to the cover member 50, and the support member 85 is interposed between the backlight unit 81 and the cover member 50.

In the example illustrated in FIG. 11, the backlight unit 81 is, for example, an edge light-type illumination device, and includes a reflecting plate 86, a light guide plate 87, and a light emitting diode (LED) unit 88. The light guide plate 87 is disposed on the reflecting plate 86, and the LED unit 88 is disposed at a side of the light guide plate 87. The LED unit 88 includes a support member 88a and a plurality of LEDs 88b. The support member 88a is disposed to face a side surface of the light guide plate 87, and the LEDs 88b are attached to the support member 88a so as to face the side surface of the light guide plate 87 and also be arranged along the side surface of the light guide plate 87.

In the example illustrated in FIG. 11, light from the LEDs 88b is emitted from the entire top surface of the light guide plate 87 by the light guide plate 87 and the reflecting plate 86. Also, the backlight unit 81 may be, for example, a direct-underneath type illumination device in which various types of optical films are disposed underneath a light source.

In this manner, light emitted from the backlight unit 81 is incident on the polarizing plate 60 of the display device 10 with a touch detection function. The light which is incident on the polarizing plate 60 passes through the display panel 10a, and therefore, an image is displayed on the top surface TS1 of the display panel 10a.

The support member 85 supports an outer peripheral portion of the display panel 10a via the cover member 50 by fixing and supporting the cover member 50. That is, the support member 85 is disposed along at least a part of the peripheral portion of the display panel 10a when seen in a plan view. The support member 85 is formed of an adhesive layer or a sticky layer. The adhesive layer or the sticky layer is formed of a resin film, such as a sponge-like double-sided tape.

In a case where the support member 85 supports the outer peripheral portion of the display panel 10a, but does not support a central portion of the display panel 10a, the display panel 10a is bent, and therefore, it is possible to prevent a central portion of the bottom surface BS1 of the display panel 10a from being scratched, and prevent dust from sticking to the central portion of the bottom surface BS1 of the display panel 10a. However, in this case, the display panel 10a is easily bent when being pressed from the top surface TS1 of the display panel 10a upon touch input, and therefore, a spot is likely to occur in a displayed image.

In a case where the display device 10 with a touch detection function, that is, the display panel 10a has a rectangular shape having four sides when seen in a plan view as illustrated in FIG. 10, the support member 85 is a frame member having, for example, a rectangular frame shape when seen in a plan view as illustrated in FIG. 10. Also, the support member 85 has an opening 90. The opening 90 is a region within a frame in the support member 85 that is a frame member. In this case, the opening 90 of the support member 85 is enveloped by the cover member 50 when seen in a plan view. That is, a size of the cover member 50 when seen in a plan view is larger than a size of the opening 90 when seen in a plan view. The support member 85 that is a frame member comes into contact with the outer peripheral portion of the display panel 10a via the cover member 50.

In a case where the opening 90 of the support member 85 is not enveloped by the cover member 50 when seen in a plan view, that is, the size of the cover member 50 when seen in a plan view is smaller than the size of the opening 90 when seen in a plan view, it is apprehended that the display panel 10a comes into contact with the support member 85. In this case, since stress is concentrated on a portion of the display panel 10a which comes into contact with the support member 85, a spot is likely to occur in an image displayed on the display device.

On the other hand, in a case where the opening 90 of the support member 85 is enveloped by the cover member 50 when seen in a plan view, that is, the size of the cover member 50 when seen in a plan view is larger than the size of the opening 90 when seen in a plan view, the display panel 10a does not come into contact with the support member 85. Therefore, it is possible to prevent stress from being concentrated on the portion of the display panel 10a which comes into contact with the support member 85, and prevent or suppress occurrence of a spot in an image displayed on the display device.

Note that, an air layer is provided in the opening 90. Here, a surface of the cover member 50 on an opposite side of a surface of the cover member 50 opposing the display panel has a first region in which the support member (second member) 85 is disposed and a second region in which the air layer is disposed.

Also, instead of the opening 90, a member (third member) which is softer than the support member (second member) 85, i.e., having a Young's modulus that is lower than that is the support member 85 may be disposed. That is, the surface of the cover member 50 on the opposite side of the surface of the cover member 50 facing the display panel 10a has a first region in which the support member 85 is disposed and a second region in which the third member that is different from the support member 85 is disposed, and the third member has a degree of elasticity that is lower than a degree of elasticity of the second member. In other words, the support member (second member) 85 is disposed opposite to the cover member 50, and the member (third member) is disposed opposite to the cover member 50. By this way, in the same manner as the way having the opening 90, stress can be dissipated not only to the support member 85 but also the third member and in addition scarring on the back surface of the display panel can be prevented.

The support member 85 includes extension parts 91, 92, 93, and 94. The extension part 91 extends in the Y axis direction when seen in a plan view, and the extension part 92 extends in the X axis direction when seen in a plan view. The extension part 93 extends in the Y axis direction when seen in a plan view, and the extension part 94 extends in the X axis direction when seen in a plan view. The extension part 93 faces the extension part 91 with the central portion of the display panel 10a being interposed therebetween when seen in a plan view, and the extension part 94 faces the extension part 92 with the central portion of the display panel 10a being interposed therebetween when seen in a plan view. In other words, the extension part 93 is separated from the extension part 91 in a plan view, and the extension part 94 is separated from the extension part 92 in a plan view. The extension parts 91, 92, 93, and 94 support the outer peripheral portion of the display panel 10a via the cover member 50.

Also, the support member 85 may include extension parts separately provided one by one for respective sides of the display panel 10a. That is, the extension parts 91, 92, 93, and 94 may be disposed to be spaced apart from one another. Alternatively, the support member 85 may include extension parts provided in a pair of sides which are opposite to each other from among four sides of the display panel 10a. That is, only the extension parts 91 and 93 or only the extension parts 92 and 94 may be provided.

In addition, the shape of the display panel 10a is not limited to a rectangular shape but may be a polygonal shape or a circular shape. Further, the support member 85 may be disposed in the first region and the second region that is separated from the first region in the outer periphery of the display panel 10a. That is, the support member 85 may include the extension part 91 as a first component formed in the first region and the extension part 93 as a second component formed in the second region separated from the first region when seen in a plan view.

Also, when an organic EL display panel, a reflection type liquid crystal display panel, or a reflection type liquid crystal display panel with a front light is used as the display panel, a frame body that fixes or accommodates the display panel instead of a backlight may be provided and the support member 85 may be provided on or inside the frame body.

<Distortion Amount of Display Panel>

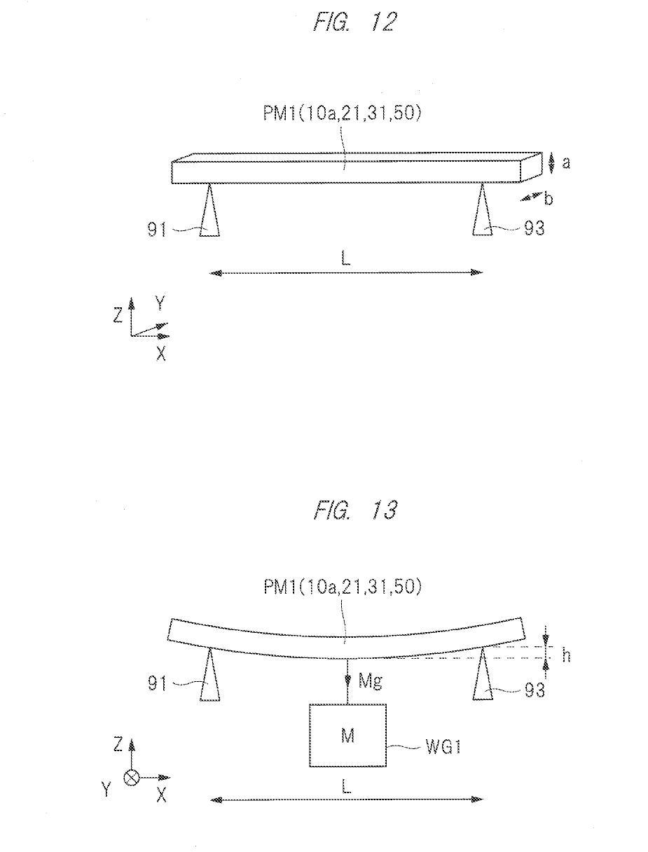

Next, a distortion amount by which the bottom surface BS1 is distorted when the display panel 10a is pressed from the top surface TS1 upon touch input will be described with reference to FIGS. 12 to 14. FIGS. 12 to 14 are diagrams for describing a calculation method for a distortion amount.

As described with reference to FIG. 10, the support member 85 has a rectangular frame shape when seen in a plan view. Therefore, each of four sides of the display panel 10a having a rectangular shape is supported by the support member 85. However, it is difficult to calculate a distortion amount when each of the four sides is supported by the support member 85. Also, a considerable time is taken to generate a structure model or perform simulations or the like, and an intuitive grasp is hardly achieved. Therefore, a simple model of two-point support is used instead below. That is, hereinafter, there will be given a description of a case where the support member 85 has two extension parts 91 and 93 respectively provided at portions overlapping the two long sides of the four sides of the display panel 10a having a rectangular shape when seen in a plan view and the two long sides of the four sides of the display panel 10a having a rectangular shape are supported by the two extension parts 91 and 93 respectively.

As illustrated in FIG. 12, as a sectional shape extending in the X axis direction and perpendicular to the X axis direction, it is considered a case where a plate member PM1 having a thickness ‘a’ in the Z axis direction and a width b in the Y axis direction is supported by the two extension parts 91 and 93 spaced apart from each other by a distance L in the X axis direction. The plate member PM1 corresponds to a laminated body including the substrate 21 and the substrate 31 which are included in the display panel 10a and the cover member 50.

As illustrated in FIG. 13, there will be considered a case in which the gravity Mg (g is acceleration of gravity) by a weight WG1 having a mass M is applied to a portion of the plate member PM1 which is disposed between the two extension parts 91 and 93, the plate member PM1 being supported by the two extension parts 91 and 93, and then the force Mg in the Z axis direction, that is, in a downward direction is added. In this case, the plate member PM1 is bent and the plate member PM1 is distorted at the portion, to which the force Mg is applied, by a distortion amount ‘h’ in the −Z axis direction.

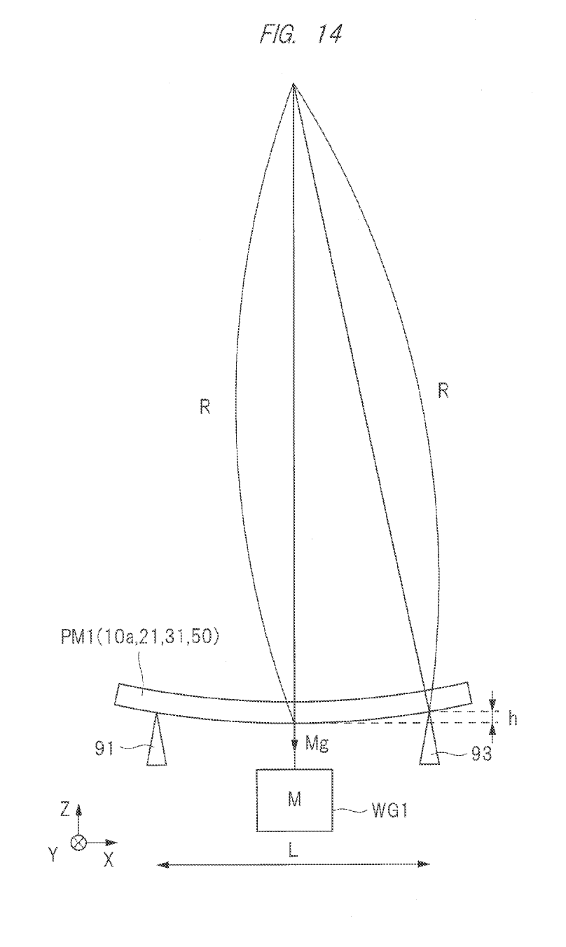

In this case, as illustrated in FIG. 14, when a curvature radius of the plate member PM1 which is bent is represented as R, the R is given by the following Formula (1):

R²=(L/2)²+(R−h)² (1)

Also, h is smaller than L and therefore, it is given by the following Formula (2):

R=L²/(8h) (2)

In the plate member PM1 which is bent, an inner side thereof is contracted and an outer side thereof is expanded, and therefore, there can be a neutral layer, which is a layer which is not expanded, and is not contracted, therebetween. There is considered a thin layer having a thickness dr, which is disposed at a distance r in an outward direction along the curvature radius from the neutral layer. When an expansion and contraction ratio of the thin layer is represented as δ=ΔL/L, and an angle of view of the thin layer is represented as θ, the following Formula (3) is given.

δ=ΔL/L={(R+r)θ−Rθ}/Rθ=r/R (3)

By the way, elastic energy W stored in the plate member PM1 which is expanded and contracted is given using the expansion and contraction ratio δ and a volume V (=b·L·dr) of the thin layer by the following formula (4):

W=(½)VEδ² (4)

An expansion and contraction ratio δ₋ of an innermost thin layer is given by the following Formula (5):

δ₋=−(a/2)/R (5)

An elastic energy thereof is given from Formula (4) by the following Formula (6):

(½)×b·L·dr×E×{−(a/2)/R}² (6)

Since an elastic energy of an intermediate layer is 0, an elastic energy W₋ of the entire inner side is considered as an average of the elastic energies of the intermediate layer and the innermost thin layer, and is given by the following Formula (7):

$$\begin{matrix}{W}_{-} = ( 1 / 2 ) \times b•L•dr \times E \times {\{ - ( a / 2 ) / R \}}^{2} / 2 \\ = ( {a}^{3} bLE ) / ( 32 {R}^{2} )\end{matrix} \qquad ( 7 )$$

The same method is applied to the outer side, and an elastic energy W₊ of the entire outer side is given by the following Formula (8):

W₊=(a³bLE)/(32R²) (8)

The elastic energy W stored in the plate member PM1 is given by the following Formula (9):

W=W₋+W₊=(a³bLE)/(16R²) (9)

The elastic energy W is a result of the fact that the gravity Mg (g is acceleration of gravity) by the weight WG1 having a mass M is applied and a portion of the plate member PM1 to which the force Mg in the −Z axis direction, that is, in a downward direction is added, receives potential energy due to the gravity caused by a descending distance by a distortion amount ‘h’. Therefore, the following Formula (10) is established.

Mgh=(a³bLE)/(16R²) (10)

A relational expression of the above Formula (10) and Formula (2) is given by the following Formula (11).

h=(MgL³)/(4a³bE) (11)

Also, a value generalized by dividing the distortion amount ‘h’ by the gravity Mg, that is, an index is represented as an index m. In this case, by dividing the both sides of the Formula (11) by the gravity Mg, the index m is given as a relational expression by the following Formula (12):

m=h/(Mg)=L³/(4a³bE) (12)

Also, a value generalized by dividing the distortion amount ‘h’ by the gravity Mg and multiplying the distortion amount ‘h’ by the Young's modulus E, that is, a shape index is represented as a shape index f. In this case, by dividing the both sides of the Formula (11) by the gravity Mg and multiplying the both sides of the Formula (11) by the Young's modulus E, the shape index f is given by the following Formula (13):

f=hE/(Mg)=L³/(4a³b) (13)

Note that, FIGS. 10 and 12 to 14 illustrate that the support member 85 includes the extension part 91 as the first component formed in the first region and the extension part 93 as the second component formed in the second region that is separated from the first region when seen in a plan view.

Also, FIGS. 10 and 12 to 14 illustrate that the surface of the cover member 50 on the opposite side of the surface of the cover member 50 facing the display panel 10a has the first region in which the support member (second member) 85 is disposed and the second region in which the air layer is disposed.

<Appropriate Range of Shape of Cover Member>

Next, there is described an appropriate range of a shape of the cover member 50 in the case of the display device according to the embodiment, that is, in the case where the cover member 50 (see FIG. 8) is made of glass is disposed on the opposite side of the display panel 10a (see FIG. 8) with the polarizing plate 60 (see FIG. 8) being interposed therebetween. In a plurality of cases in which the cover member 50 has a different thickness a50, the distortion amount ‘h’ or the like is calculated using the Formula (11) to Formula (13).

Also, in the plurality of cases in which the cover member 50 has a different thickness a50, a plurality of display devices have been manufactured, and evaluation was performed to determine whether a spot is observed. Specifically, evaluation was performed to determine whether an outer peripheral spot is observed in the display panel 10a when the display panel 10a is pressed from the top surface TS1 by the force Mg corresponding to the gravity Mg of 49 N (5 kgf). Also, evaluation was performed to determine whether a peripheral spot is observed in the display panel 10a when the display panel 10a is pressed from the top surface TS1 by the force Mg corresponding to the gravity Mg of 49 N (5 kgf). The outer peripheral spot represents a spot occurring in a portion supported at four points in the display panel 10a, that is, a portion supported by the support member 85. Also, a peripheral spot represents a spot occurring on the periphery of a pressed portion.

Also, the spot represents a case where an image is not displayed correctly at a local portion, specifically, for example, an image is thinned locally or a case where an image is whitened locally (which is similarly applied to modification examples of the embodiment below). As a cause of such a spot, it is considered that, when being strongly pressed, a thickens of a liquid crystal layer which is maintained by two sheets of glass is changed locally, and therefore, luminance is changed due to a change in retardation, or luminance is changed because the alignment state of the liquid crystal is disordered.

In the present embodiment, the thickness of the substrate 21 is represented by a thickness a21 (see FIG. 8), the thickness of the substrate 31 is represented by a thickness a31 (see FIG. 8), and the thickness of the cover member 50 is represented by a thickness a50 (see FIG. 8). Also, the thickness of the laminated body made up of the substrate 21, the substrate 31, and the cover member 50 is represented by a total of the thickness a21, the thickness a31, and the thickness a50, and the Young's modulus E of the laminated body is represented by the Young's modulus E of glass that is material of the substrate 21, the substrate 31, and the cover member 50. Since the liquid crystal layer 6, the adhesive layer 51, the polarizing plates 60 and 70, and the like have relatively low Young's modulus and thicknesses compared to the substrate 21, the substrate 31, and the cover member 50, approximation was performed in disregard of their contribution.

A case where the cover member 50 is not provided is represented as comparative example 1 and a case where the cover member 50 is provided is represented as examples 1 to 6. The thickness a50 of the cover member 50 is respectively set to 0.25 mm, 0.5 mm, 0.75 mm, 1 mm, 1.25 mm, and 1.5 mm in examples 1 to 6. A result of evaluation of comparative example 1 and embodiments 1 to 6 is represented in Table 1. In Table 1, a case where a spot is observed is represented as “x”, a case where a spot is observed but an improvement is made compared to comparative example 1 is represented as “◯”, and a case where a spot is not observed is represented as “⊙”.

TABLE 1

| | Comparative | | | | | | |
|---|---|---|---|---|---|---|---|
| | Example 1 | Example 1 | Example 2 | Example 3 | Example 4 | Example 5 | Example 6 |
| Thickness a21 (mm) | 0.5 | 0.5 | 0.5 | 0.5 | 0.5 | 0.5 | 0.5 |
| Thickness a31 (mm) | 0.5 | 0.5 | 0.5 | 0.5 | 0.5 | 0.5 | 0.5 |
| Thickness a50 (mm) | 0 | 0.25 | 0.5 | 0.75 | 1 | 1.25 | 1.5 |
| Distance L (mm) | 300 | 300 | 300 | 300 | 300 | 300 | 300 |
| Distance b (mm) | 200 | 200 | 200 | 200 | 200 | 200 | 200 |
| Thickness a (mm) | 1 | 1.25 | 1.5 | 1.75 | 2 | 2.25 | 2.5 |
| Pushing force | 49.035 | 49.035 | 49.035 | 49.035 | 49.035 | 49.035 | 49.035 |
| Mg (N) | | | | | | | |
| Young's modulus | 71591.1 | 71591.1 | 71591.1 | 71591.1 | 71591.1 | 71591.1 | 71591.1 |
| E (MPa) | | | | | | | |
| Distortion amount | 23.11644 | 11.83562 | 6.849315 | 4.313271 | 2.889555 | 2.029427 | 1.479452 |
| h (mm) | | | | | | | |
| (calculated value) | | | | | | | |
| Outer peripheral | X | ◯ | ◯ | ⊚ | ⊚ | ⊚ | ⊚ |
| spot (experimental | | | | | | | |
| result) | | | | | | | |
| Peripheral spot | X | ◯ | ⊚ | ⊚ | ⊚ | ⊚ | ⊚ |
| (experimental result) | | | | | | | |
| Index m (mmN⁻¹) | 0.471427 | 0.241371 | 0.139682 | 0.087963 | 0.058928 | 0.041387 | 0.030171 |
| Shape index | 33750 | 17280 | 10000 | 6297.376 | 4218.75 | 2962.963 | 2160 |
| f (mm⁻¹) | | | | | | | |

As shown in Table 1, in comparative example 1, the outer peripheral spot and the peripheral spot are both observed. On the other hand, in example 1, the outer peripheral spot and the peripheral spot both are hardly observed compared to comparative example 1, thereby achieving an improvement. Also, in example 2, the outer peripheral spot is hardly observed compared to comparative example 1 to achieve an improvement, and the peripheral spot is not observed. Also, in examples 3 to 6, the outer peripheral spot and the peripheral spot both are not observed.

Therefore, preferably, the thickness a50 of the cover member 50 is equal to or greater than 0.5 mm, and the distortion amount ‘h’ (mm) obtained from the Formula (11) is equal to or lower than 6.8 mm. That is, the substrate 21, the substrate 31, and the cover member 50 are respectively made of glass, a total of the thicknesses of the substrate 21, the substrate 31, and the cover member 50 is represented as a thickness ‘a’ (mm), a distance between the extension part 92 and the extension part 94 is represented as b (mm), and a distance between the extension part 91 and the extension part 93 is represented as L (mm). Thereby, the distortion amount ‘h’ (mm) obtained from the Formula (11) is equal to or lower than 6.8 mm. That is, (MgL³)/(4a³bE)≦6.8 is established.

In this case, even when the display panel 10a is pressed from the top surface TS1 by the force of 49 N, at least a peripheral spot is not observed, thereby improving visibility of an image displayed on the display device.

In other words, preferably, an index m (mmN⁻¹) obtained by the Formula (12) is equal to or lower than 0.14 mmN⁻¹. That is, the substrate 21, the substrate 31, and the cover member 50 are respectively made of glass, a total of the thicknesses of the substrate 21, the substrate 31, and the cover member 50 is represented as a thickness ‘a’ (mm), a distance between the extension part 92 and the extension part 94 is represented as a distance ‘b’ (mm), and a distance between the extension part 91 and the extension part 93 is represented as a distance L (mm). When the Young's modulus of glass is represented as Young's modulus E (MPa), an index m (mmN⁻¹) obtained by the Formula (12) is equal to or lower than 0.14 mmN⁻¹. That is, L³/(4a³bE)≦0.14 is established.

In this case, even when the display panel 10a is pressed from the top surface TS1 by the force of 49 N, the distortion amount ‘h’ (mm) obtained by the Formula (11) is equal to or lower than 6.8 mm. Therefore, even when the display panel 10a is pressed from the top surface TS1 by the force of 49 N, at least a peripheral spot is not observed, thereby improving visibility of an image displayed on the display device.

In other words, preferably, a shape index f (mm⁻¹) obtained by the Formula (13) is equal to or lower than 10000 mm⁻¹. That is, the substrate 21, the substrate 31, and the cover member 50 are respectively made of glass, a total of the thicknesses of the substrate 21, the substrate 31, and the cover member 50 is represented as a thickness ‘a’ (mm), a distance between the extension part 92 and the extension part 94 is represented as a distance ‘b’ (mm), and a distance between the extension part 91 and the extension part 93 is represented as a distance L (mm). Thereby, the shape index f (mm⁻¹) obtained from the Formula (13) is equal to or lower than 10000 mm⁻¹. That is, L³/(4a³b)≦10000 is established.

In this case, even when the display panel 10a is pressed from the top surface TS1 by the force of 49 N in the case where the Young's modulus E of glass is 72000 MPa, the distortion amount ‘h’ (mm) obtained by the Formula (11) is equal to or lower than 6.8 mm. Therefore, even when the display panel 10a is pressed from the top surface TS1 by the force of 49 N, at least a peripheral spot is not observed, thereby improving visibility of an image displayed on the display device.

As described above, the appropriate range of a shape of the cover member 50 in the display device according to the present embodiment may be defined by any one of the distortion amount ‘h’, the index m, and the shape index f.

<Main Features of Present Embodiment>

In the display device having an electrostatic capacitive type touch panel, when the cover member made of, for example, glass is provided on a surface of the display device having a touch panel, for example, for the purpose of reinforcing the strength of the display device, an intensity of the detecting signal for the cover member is reduced.

Therefore, when the cover member is not provided on the surface of the display device having a touch panel, the display device is easily bent in such a way that the display device is pressed from the surface. Also, the display panel is supported in such a way that four side portions of a rear surface of the display panel come into contact with a support member for example, for the purpose not to damage the rear surface of the display panel. Therefore, when the cover member is not provided on the surface of the display device having a touch panel, the display panel is more easily bent. In addition, a spot occurs on an image displayed on the display device due to bending of the display panel.

On the other hand, the display device according to the present embodiment includes the cover member 50 that covers the bottom surface BS1 of the opposite side of the top surface TS1 on which the image of the display panel 10a is displayed. Thereby, the distortion amount in a case where the display panel 10a is pressed from the top surface TS1 can be reduced, compared to a case where the display device does not include the cover member 50. Therefore, when the display panel 10a is pressed from the top surface TS1, a peripheral spot or the like is not observed in an image displayed on the display device, improving visibility of an image displayed on the display device. That is, in the display device according to the present embodiment, it is possible to prevent or suppress bending of the display panel 10a upon touch input, preventing or suppressing occurrence of a spot in an image displayed on the display device.

Preferably, another cover member is not provided on the opposite side of the cover member 50 with the display panel 10a being interposed therebetween, and the polarizing plate 70 provided on the top surface TS1 of the display panel 10a is exposed. Therefore, it is possible to prevent or suppress reduction in intensity of the detecting signal in the case of touch input, achieving touch detection intensity and preventing and suppressing occurrence of a spot due to bending of the display panel 10a.

Also, when the cover member 50 which covers the bottom surface BS1 of the display panel 10a is not provided and the thickness a21 of the substrate 21 or the thickness a31 of the substrate 31 is increased, it is impossible to apply, as it is, an existing manufacturing method of the array substrate 2 and the opposing substrate 3 which there is a necessity to change an existing manufacturing condition or manufacturing device of the array substrate 2 and the opposing substrate 3. On the other hand, since there is no necessity to increase the thickness a21 of the substrate 21 and the thickness a31 of the substrate 31 in the present embodiment, it is possible to apply the existing manufacturing method of the array substrate 2 and the opposing substrate 3, as it is.

<First Modification Example of Display Panel>

Next, a first modification example of the display panel will be described with reference to FIG. 15. FIG. 15 is a sectional view illustrating a support structure by a cover member of a display panel in a display device according to a first modification example of the embodiment.

A display device according to the first modification example is substantially identical to the display device according to the embodiment, except that the polarizing plate 60 is provided on the opposite side of the display panel 10a with the cover member 50 being interposed therebetween. Also, in the first modification example, the polarizing plate 60 is an example of a third polarizing plate.

The cover member 50 covers the bottom surface BS1 of the display panel 10a. In the example illustrated in FIG. 15, the cover member 50 covers the bottom surface that is a surface of the array substrate 2 on the opposite side of the opposing substrate 3, that is, the bottom surface BS1 of the display panel 10a. Also, the cover member 50 is adhered to, via the adhesive layer 51, the bottom surface that is the surface of the array substrate 2 on the opposite side of the opposing substrate 3, that is, the bottom surface BS1 of the display panel 10a.

In the same manner as the embodiment, also in the first modification example, the cover member 50 which covers the bottom surface BS1 of the display panel 10a is provided and therefore, it is possible to prevent or suppress occurrence of a spot in an image displayed on the display panel 10a even when the display panel 10a is pressed from the top surface TS1 upon touch input.

In the same manner as the embodiment, also in the first modification example, preferably, in the surface of the cover member 50 on the polarizing plate 60 side, a part overlapping the polarizing plate 60 when seen in a plan view is adhered to the polarizing plate 60 by its entire surface. In other words, a portion of the cover member 50, which overlaps the polarizing plate 60 in a plan view, is adhered to the polarizing plate 60 by an entire surface thereof. In this manner, upon touch input, it is possible to more surely prevent or suppress occurrence of a spot in an image displayed on the display panel 10a when the display panel 10a is pressed from the top surface TS1 side.

A preferable range of a shape of the cover member 50 in the display device according to the first modification example is defined by any of the distortion amount ‘h’, the index m, and the shape index f, which are obtained by Table 1 and the Formula (11) to Formula (13), thereby obtaining the same range as an appropriate range of a shape of the cover member 50 in the display device of the embodiment. The reason for this is that a thickness of a laminated body including the substrate 21, the substrate 31, and the cover member 50 is a total of the thickness a21 of the substrate 21, the thickness a31 of the substrate 31, and the thickness a50 of the cover member 50 in all of the embodiment and the first modification example. Therefore, although a positional relationship of the polarizing plate 60 and the cover member 50 is reversed between the embodiment and the first modification example, the preferable range of a shape of the cover member 50 obtained in the first modification example becomes identical to a preferable range of a shape of the cover member 50 obtained in the embodiment.

<Second Modification Example of Display Panel>

Next, a second modification example of the display panel will be described with reference to FIG. 16. FIG. 16 is a sectional view illustrating a support structure by a cover member of a display panel in a display device according to a second modification example of the embodiment.

In the display device of the second modification example, the cover member 50 is made of acrylic. Also, the display device of the second modification example can be substantially identical to the display device of the embodiment, except that the cover member 50 is made of acrylic.

Similarly to the embodiment, also in the second modification example, the cover member 50 which covers the bottom surface BS1 of the display panel 10a is provided and therefore, it is possible to prevent or suppress occurrence of a spot in an image displayed on the display panel 10a even when the display panel 10a is pressed from the top surface TS1 upon touch input.

Since Young's modulus of acrylic is lower than the Young's modulus of glass, in a case where the cover member 50 having a certain thickness is made of acrylic, a distortion amount by which the bottom surface BS1 is increased when the display panel 10a is pressed from the top surface TS1, compared to a case where the cover member 50 having the same thickness as the certain thickness is made of glass. However, the acrylic has a lower mass and is less likely to break, compared to the glass. Therefore, in applications where the display device is lightened even slightly or impact is applied to the display device, the case where the cover member 50 is made of acrylic is benefit, compared to the case where the cover member 50 is made of glass.

Next, there is described an appropriate range of a shape of the cover member 50 in the case of the display device according to the second modification example, that is, in the case where the cover member 50 is made of acrylic is disposed on the opposite side of the display panel 10a with the polarizing plate 60 being interposed therebetween. In a plurality of cases in which the cover member 50 has different thicknesses a50, the distortion amount ‘h’ or the like is calculated using the Formula (11) to Formula (13).

Also, in the plurality of cases in which the cover member 50 has a different thickness a50, a plurality of display devices have been manufactured, and evaluation was performed to determine whether a spot is observed. Specifically, evaluation was performed to determine whether an outer peripheral spot is observed in the display panel 10a when the display panel 10a is pressed from the top surface TS1 by the force Mg corresponding to the gravity Mg of 49 N (5 kgf). Also, evaluation was performed to determine whether an outer peripheral spot is observed in the display panel 10a when the display panel 10a is pressed from the top surface TS1 by the force Mg corresponding to the gravity Mg of 49 N (5 kgf). Similarly to the embodiment, the outer peripheral spot refers to a spot occurring in a portion supported at four points in the display panel 10a, that is, a portion supported by the support member 85. Also, a peripheral spot represents a spot occurring on the periphery of a pressed portion.

In the second modification example, the thickness of the substrate 21 is represented as a thickness a21 (see FIG. 16), the thickness of the substrate 31 is represented as a thickness a31 (see FIG. 16), and the thickness of the cover member 50 is represented as a thickness a50 (see FIG. 16). Also, the Young's modulus of glass that is a material of the substrate 21 and the substrate 31 is represented as Young's modulus Eg and the Young's modulus of acrylic that is a material of the cover member 50 is represented as Young's modulus Ea. In addition, the thickness of a laminated body made up of the substrate 21, the substrate 31, and the cover member 50 is represented as a total of the thicknesses a21, a31, and a50 and the Young's modulus E of the laminated body is obtained by adding values obtained by multiplying the Young's modulus of each of the substrate 21, the substrate 31, and the cover member 50 by a ratio corresponding to a ratio of the respective thicknesses of the substrate 21, the substrate 31, and the cover member 50. Since the liquid crystal layer 6, the adhesive layer 51, and the polarizing plates 60 and 70 have relatively low Young's modulus and thicknesses compared to the substrate 21, the substrate 31, and the cover member 50, approximation was performed in disregard of their contribution.

A case where the cover member 50 is not provided is represented as comparative example 2 and a case where the cover member 50 is provided is represented as examples 7 to 12. The thickness of the cover member 50 is respectively set to 0.25 mm, 0.5 mm, 0.75 mm, 1 mm, 1.25 mm, and 1.5 mm in examples 7 to 12. A result of evaluation of comparative example 2 and examples 7 to 12 is represented in Table 2. In Table 2, a case where a spot is observed is represented as “x”, a case where a spot is observed but an improvement is made compared to comparative example 2 is represented as “◯”, and a case where a spot is not observed is represented as “⊙”. Also, the comparative example 2 is the same comparative example as the comparative example 1 in the embodiment.

TABLE 2

| | Comparative | | | | Example | Example | Example |
|---|---|---|---|---|---|---|---|
| | Example 2 | Example 7 | Example 8 | Example 9 | 10 | 11 | 12 |
| Thickness a21 (mm) | 0.5 | 0.5 | 0.5 | 0.5 | 0.5 | 0.5 | 0.5 |
| Thickness a31 (mm) | 0.5 | 0.5 | 0.5 | 0.5 | 0.5 | 0.5 | 0.5 |
| Thickness a50 (mm) | 0 | 0.25 | 0.5 | 0.75 | 1 | 1.25 | 1.5 |
| Distance L (mm) | 300 | 300 | 300 | 300 | 300 | 300 | 300 |
| Distance b (mm) | 200 | 200 | 200 | 200 | 200 | 200 | 200 |
| Thickness a (mm) | 1 | 1.25 | 1.5 | 1.75 | 2 | 2.25 | 2.5 |
| Pushing force | 49.035 | 49.035 | 49.035 | 49.035 | 49.035 | 49.035 | 49.035 |
| Mg (N) | | | | | | | |
| Young's modulus | 71591.1 | 71591.1 | 71591.1 | 71591.1 | 71591.1 | 71591.1 | 71591.1 |
| Eg (MPa) | | | | | | | |
| Young's modulus | 3138.24 | 3138.24 | 3138.24 | 3138.24 | 3138.24 | 3138.24 | 3138.24 |
| Ea (MPa) | | | | | | | |
| Young's modulus | 71591.1 | 56645.23 | 46681.32 | 39564.24 | 34226.43 | 30074.8 | 26753.5 |
| E (MPa) | | | | | | | |
| Distortion amount | 23.11644 | 14.95845 | 10.5042 | 7.804821 | 6.044054 | 4.830917 | 3.958944 |
| h (mm) | | | | | | | |
| (calculated value) | | | | | | | |
| Outer peripheral | X | ◯ | ◯ | ⊚ | ⊚ | ⊚ | ⊚ |
| spot (experimental | | | | | | | |
| result) | | | | | | | |
| Peripheral spot | X | ◯ | ⊚ | ⊚ | ⊚ | ⊚ | ⊚ |
| (experimental result) | | | | | | | |
| Index m (mmN⁻¹) | 0.471427 | 0.305057 | 0.214218 | 0.159168 | 0.12326 | 0.09852 | 0.080737 |
| Shape index | 33750 | 17280 | 10000 | 6297.376 | 4218.75 | 2962.963 | 2160 |
| f (mm⁻¹) | | | | | | | |

As shown in Table 2, in comparative example 2, the outer peripheral spot and the peripheral spot are both observed. On the other hand, in example 7, the outer peripheral spot and the peripheral spot both are hardly observed compared to comparative example 2, thereby achieving an improvement. Also, in example 8, the outer peripheral spot is hardly observed compared to comparative example 2 to achieve an improvement, and the peripheral spot is not observed. Also, in examples 9 to 12, the outer peripheral spot and the peripheral spot both are not observed.

Therefore, preferably, the thickness a50 of the cover member 50 is equal to or greater than 0.5 mm, and the distortion amount ‘h’ (mm) obtained by Formula (11) is equal to or lower than 10.5 mm. That is, the substrate 21 and the substrate 31 are respectively made of glass, the cover member 50 is made of acrylic, a total of the thicknesses of the substrate 21, the substrate 31, and the cover member 50 is represented as a thickness ‘a’ (mm), a distance between the extension part 92 and the extension part 94 is represented as a distance ‘b’ (mm), and a distance between the extension part 91 and the extension part 93 is represented as a distance L (mm). Thereby, the distortion amount ‘h’ (mm) obtained from the Formula (11) is equal to or lower than 10.5 mm. That is, (MgL³)/(4a³bE)≦10.5 is established.

In this case, even when the display panel 10a is pressed from the top surface TS1 by the force of 49 N, at least a peripheral spot is not observed, thereby improving visibility of an image displayed on the display device.

In other words, preferably, an index m (mmN⁻¹) obtained by the Formula (12) is equal to or lower than 0.21 mmN⁻¹. That is, the substrate 21 and the substrate 31 are respectively made of glass, the cover member 50 is made of acrylic, a total of the thicknesses of the substrate 21, the substrate 31, and the cover member 50 is represented as a thickness ‘a’ (mm), a distance between the extension part 92 and the extension part 94 is represented as a distance ‘b’ (mm), and a distance between the extension part 91 and the extension part 93 is represented as a distance L (mm). When the Young's modulus of the laminated body is represented as Young's modulus E (MPa), an index m (mmN⁻¹) obtained by the Formula (12) is equal to or lower than 0.21 mmN⁻¹. That is, L³/(4a³bE)≦0.21 is established.

In this case, even when the display panel 10a is pressed from the top surface TS1 by the force of 49 N, the distortion amount ‘h’ (mm) obtained by the Formula (11) is equal to or lower than 10.5 mm. Therefore, even when the display panel 10a is pressed from the top surface TS1 by the force of 49 N, at least a peripheral spot is not observed, thereby improving visibility of an image displayed on the display device.

In other words, preferably, a shape index f (mm⁻¹) obtained by the Formula (13) is equal to or lower than 10000 mm⁻¹. That is, the substrate 21 and the substrate 31 are respectively made of glass, the cover member 50 is made of acrylic, a total of the thicknesses of the substrate 21, the substrate 31, and the cover member 50 is represented as a thickness ‘a’ (mm), a distance between the extension part 92 and the extension part 94 is represented as a distance ‘b’ (mm), and a distance between the extension part 91 and the extension part 93 is represented as a distance L (mm). Thereby, the shape index f (mm⁻¹) obtained from the Formula (13) is equal to or lower than 10000 mm⁻¹. That is, L³/(4a³b)≦10000 is established.

In this case, even when the display panel 10a is pressed from the top surface TS1 by the force of 49 N in the case where the Young's modulus Eg of glass is 72000 MPa and the Young's modulus Ea of acrylic is 3100 MPa, the distortion amount ‘h’ (mm) obtained by the Formula (11) is equal to or lower than 10.5 mm. Therefore, even when the display panel 10a is pressed from the top surface TS1 by the force of 49 N, at least a peripheral spot is not observed, thereby improving visibility of an image displayed on the display device.

<Touch Detection Function According to Self-Capacitance Method>

In the embodiment and the first and second modification examples thereof, there has been described an example of applying, as a touch panel, a mutual-capacitance type touch panel in which driving electrodes and detecting electrodes are provided. However, it is possible to apply a self-capacitance type touch panel in which detecting electrodes are only provided, as a touch panel.

In this specification, the detecting electrode TDL represents an electrode that detects a change in an electrostatic capacitance, which is caused by a capacitance by a finger but functions of the detecting electrode TDL in the mutual capacitance method and the self-capacitance method are different. Therefore, a detecting electrode TDL that performs detection after electric charges are given in the self-capacitance method is referred to as a detecting electrode TDLb below. On the other hand, as illustrated in FIG. 7, the detecting electrode TDL that performs only detection in the mutual capacitance method is referred to as a detecting electrode TDLa.

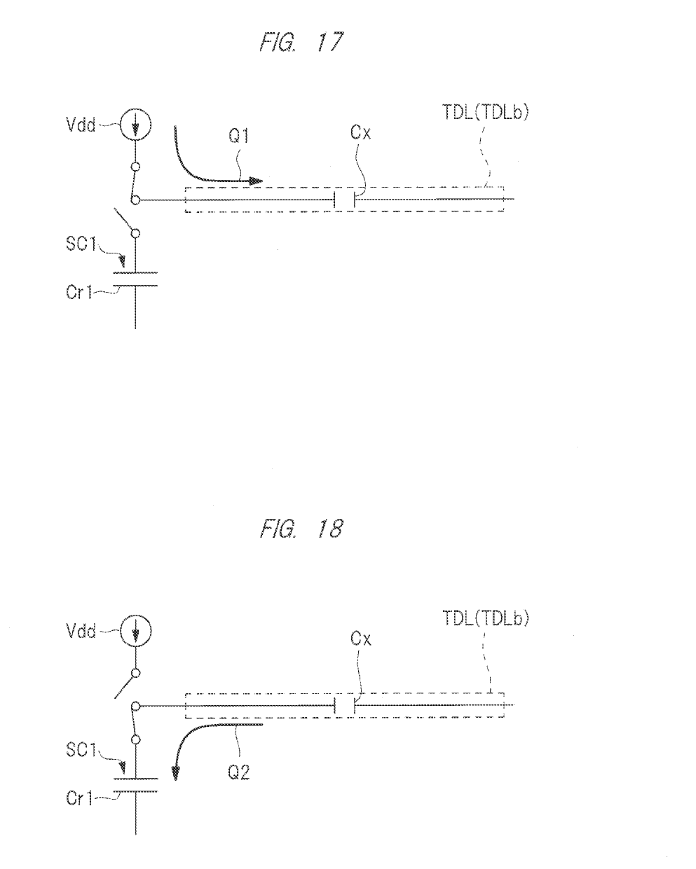

FIGS. 17 and 18 are explanatory diagrams illustrating an electrical connection state of electrostatic capacitive type detecting electrodes.

In the touch panel according to the self-capacitance method, as illustrated in FIG. 17, when the detecting electrode TDLb serving as a detecting electrode TDL having an electrostatic capacitance Cx is separated from a detecting circuit SC1 having an electrostatic capacitance Cr1, and is electrically coupled to a power supply Vdd, an electric charge amount Q1 is accumulated in the detecting electrode TDLb having the electrostatic capacitance Cx. Next, as illustrated in FIG. 18, when the detecting electrode TDLb having the electrostatic capacitance Cx is separated from the power supply Vdd and is electrically coupled to the detecting circuit SC1 having the electrostatic capacitance Cr1, an electric charge amount Q2 is accumulated in the detecting circuit SC1.

In this case, when a finger contacts or approaches the detecting electrode TDLb, the electrostatic capacitance Cx of the detecting electrode TDLb is changed due to a capacitance by the finger, and when the detecting electrode TDLb is coupled to the detecting circuit SC1, the electric charge amount Q2 flowing out to the detecting circuit SC1 is also changed. Therefore, it is possible to determine whether the finger contacts or approaches the detecting electrode TDLb by measuring electric charge amount Q2 that flows out, by the detecting circuit SC1 and detecting a change in the electrostatic capacitance Cx of the detecting electrode TDLb.

Alternatively, the display device may include a plurality of detecting electrodes TDLb respectively extending in the X axis direction (see FIG. 4) and arranged at intervals in the Y axis direction (see FIG. 4) intersecting, preferably perpendicular to the X axis direction, and a plurality of detecting electrodes TDLb respectively extending in the Y axis direction and arranged at intervals in the X axis direction. In this case, it is possible to detect an input position two-dimensionally by detecting a change in the electrostatic capacitance Cx of the plurality of detecting electrodes TDLb extending in respective directions.

Also, the display device may include a plurality of detecting electrodes TDLb arranged in a matrix form in the X axis direction and the Y axis direction. In this case, it is possible to detect an input position two-dimensionally by detecting a change in the electrostatic capacitance Cx of the plurality of detecting electrodes TDLb arranged in a matrix form.

Similarly to the embodiment and the first and second modification examples thereof, the display device including a touch panel according to the self-capacitance method may also include a cover member 50 that covers the bottom surface BS1 on the opposite side of the top surface TS1 on which an image of the display panel 10a is displayed. Thereby, it is possible to prevent or suppress bending of the display panel 10a upon touch input, preventing or suppressing occurrence of an outer peripheral spot or a peripheral spot in an image displayed on the display device.

In the foregoing, the invention made by the inventors of the present invention has been concretely described based on the embodiments. However, it is needless to say that the present invention is not limited to the foregoing embodiments and various modification examples and alterations can be made within the scope of the present invention.

Further, in the foregoing embodiments, the cases of a liquid crystal display device have been illustrated as disclosure examples, but all kinds of flat-panel display devices such as an organic EL display device, other self-luminous type display devices and electronic paper display devices having electrophoresis elements may be listed as other application examples. Further, it goes without saying that the present invention is applicable to small, medium and large sized devices without any particular limitation.

In the category of the idea of the present invention, a person with ordinary skill in the art can conceive various modification examples and revised examples, and such modification examples and revised examples are also deemed to belong to the scope of the present invention.

For example, the examples obtained by appropriately making the additions, deletions or design changes of components or the additions, deletions or condition changes of processes to respective embodiments described above by a person with ordinary skill in the art also belong to the scope of the present invention as long as they include the gist of the present invention.

The present invention is effectively applied to a display device.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A display device comprising:
a display panel having a first surface and a second surface that is on an opposite side of the first surface, and displaying an image on the first surface; and
a first member covering the second surface of the display panel,
wherein the display panel includes a detecting element detecting an object approaching the first surface, and
the first member is adhered to the second surface via an adhesive layer.

2. The display device according to claim 1,
wherein the display panel includes a first polarizing plate provided on the first surface of the display panel, and
the first polarizing plate is exposed.

3. The display device according to claim 1,
wherein the display panel includes a second polarizing plate provided on the second surface of the display panel, and
the first member is adhered to the second polarizing plate via the adhesive layer.

4. The display device according to claim 1, further comprising a third polarizing plate provided on an opposite side of the display panel with the first member being interposed between the third polarizing plate and the display panel.

5. The display device according to claim 1, further comprising a second member disposed opposite to the display panel,
the first member being interposed between the second member and the display panel,
the second member being disposed along at least a part of an outer peripheral portion of the display panel in a plan view.

6. The display device according to claim 5,
wherein the display panel is a liquid crystal display panel, and
the display device further comprises a backlight disposed opposite to the first member,
the second member being interposed between the backlight and the first member.

7. The display device according to claim 1,
wherein the display panel includes a first substrate and a second substrate, and
the first member is made of a material having a Young's modulus which is equal to or greater than a Young's modulus of the first substrate or which is equal to or greater than a Young's modulus of the second substrate.

8. The display device according to claim 1,
wherein the first member is made of glass.

9. The display device according to claim 1,
wherein the first member is made of plastic.

10. The display device according to claim 1,
wherein the adhesive layer is formed of a resin film.

11. The display device according to claim 5,
wherein the second member is a frame member having a rectangular frame shape in a plan view.

12. The display device according to claim 3,
wherein a portion of the first member which overlaps the second polarizing plate in a plan view is adhered to the second polarizing plate by an entire surface of the portion.

13. The display device according to claim 4,
wherein a portion of the first member which overlaps the third polarizing plate in a plan view is adhered to the third polarizing plate by an entire surface of the portion.

14. The display device according to claim 1, further comprising
a second member disposed opposite to the display panel,
the first member being interposed between the second member and the display panel,
the second member including:
a first component formed in a first region; and
a second component formed in a second region that is separated from the first region in a plan view.

15. The display device according to claim 1,
wherein a second member is disposed opposite to the first member,
a third member is disposed opposite to the first member, and
the third member has a degree of elasticity lower than a degree of elasticity of the second member.

16. The display device according to claim 1,
wherein a surface of the first member on an opposite side of a surface of the first member facing the display panel has a first region in which a second member is disposed and a second region in which an air layer is disposed.

17. The display device according to claim 5,
wherein the second member includes:
a first extension part extending in a first direction;
a second extension part extending in a second direction intersecting the first direction;
a third extension part extending in the first direction and separated from the first extension part in a plan view; and
a fourth extension part extending in the second direction and separated from the second extension part in a plan view, and
each of the first extension part, the second extension part, the third extension part, and the fourth extension part supports an outer peripheral portion of the display panel via the first member.

18. The display device according to claim 17,
wherein the display panel includes a third substrate and a fourth substrate,
each of the third substrate, the fourth substrate, and the first member is made of glass, and
when a total of thicknesses of the third substrate, the fourth substrate, and the first member are represented as ‘a’ (mm), a distance between the second extension part and the fourth extension part is represented as ‘b’ (mm), and a distance between the first extension part and the third extension part is represented as ‘L’ (mm), L³/(4a³b)≦10000 is established.
